(19) United States
(12) Patent Application Publication
(10) Pub. No.: US 2013/0341525 A1
(43) Pub. Date: Dec. 26, 2013

(54) RADIATION IMAGE CAPTURING APPARATUS AND RADIATION IMAGE CAPTURING SYSTEM

(71) Applicant: Konica Minolta, Inc., Tokyo (JP)

(72) Inventors: Yuuichi MARUTA, Tokyo (JP); Kaneyuki NAKANO, Tokyo (JP)

(21) Appl. No.: 13/921,661

(22) Filed: Jun. 19, 2013

(30) Foreign Application Priority Data
Jun. 21, 2012 (JP) 2012-139267

(51) Int. Cl. G01T 1/17

(52) U.S. Cl. CPC G01T 1/17
USPC 250/394

(57) ABSTRACT

A radiation image capturing apparatus includes a control unit. The control unit alternately carries out (a) a leak data readout process to read out electric charges leaking from radiation detection elements via switch elements set in an OFF state as leak data and (b) a reset process of the radiation detection elements. When a value of the leak data read out in the leak data readout process is equal to or greater than a threshold, the control unit repeats the leak data readout process, skipping the reset process. The control unit detects start of irradiation of the radiation image capturing apparatus when a value of the leak data read out in the repeated readout process is again equal to or greater than the threshold, and does not detect start of the irradiation when the value is smaller than the threshold.

The present invention claims priority under 35 U.S.C. §119 to Japanese Application No. 2012-139267 filed Jun. 21, 2012, the entire content of which is incorporated herein by reference.

### BACKGROUND OF THE INVENTION

1. Field of the Invention

The present invention relates to a radiation image capturing apparatus and a radiation image capturing system, and in particular, relates to a radiation image capturing apparatus which captures a radiation image by detecting start of irradiation and a radiation image capturing system using the radiation image capturing apparatus.

2. Description of the Related Art

Various kinds of the so-called direct-type radiation image capturing apparatus and the so-called indirect-type radiation image capturing apparatus have been developed. The direct-type radiation image capturing apparatus generates electric charges using detection elements according to the radiation dose of, for example, received X-rays and converts the electric charges into electric signals. The indirect-type radiation image capturing apparatus first converts received radiation into light of another wavelength such as visible light by using, for example, a scintillator, generates electric charges according to the amount of energy of the converted light using photoelectric conversion elements such as photodiodes and then converts the electric charges into electric signals (i.e., image data). In the present invention, the detection elements of the direct-type radiation image capturing apparatus and the photoelectric conversion elements of the indirect-type radiation image capturing apparatus are collectively called radiation detection elements.

Radiation image capturing apparatuses of these types are known as FPD (Flat Panel Detector), and each used to be formed integrally with a support and called by such a name as a specialized type or a fixed type (for example, refer to Japanese Patent Application Laid-Open Publication No. hei 09-73144). Recently, portable radiation image capturing apparatuses of these types made by placing radiation detection elements and other parts in a housing have been developed and put into practical use (for example, refer to Japanese Patent Application Laid-Open Publication No. 2006-058124 or Japanese Patent Application Laid-Open Publication No. hei 06-342099).

As shown in, for example, FIG. 3 described below, in these radiation image capturing apparatuses, normally radiation detection elements 7 are arranged two-dimensionally (in a matrix) over a detection unit P, and switch elements 8 each constituted by, for example, a thin film transistor (hereafter referred to as TFT) are connected to the radiation detection elements 7 one-to-one.

Normally, a radiation image is captured by emitting radiation from a radiation source of a radiation generation apparatus and irradiating a radiation image capturing apparatus with the radiation that has passed through the body or another part of a subject. After the radiation image is captured, ON voltage is sequentially applied to lines L1 to Lx of scan lines 5 from a gate driver 15b to sequentially set the TFTs 8 to an ON state. Electric charges generated by irradiation in the radiation detection elements 7 and accumulated therein are sequentially released to signal lines 6 and read out as image data D by readout circuits 17.

Incidentally, in a conventional radiation image capturing system using such a radiation image capturing apparatus, signals are transmitted between the radiation image capturing apparatus and a radiation generation apparatus to capture a radiation image. However, for example, when manufactures of the radiation image capturing apparatus and the radiation generation apparatus are different, it is not always easy to build an interface between the radiation image capturing apparatus and the radiation generation apparatus or it may be impossible to build the interface.

In such a case, the radiation image capturing apparatus cannot know the timing at which the radiation generation apparatus emits radiation thereto. Therefore, in such a case, the radiation image capturing apparatus should be configured such that the radiation image capturing apparatus can detect the irradiation by itself. Various kinds of such radiation image capturing apparatuses capable of detecting start of the irradiation by itself have been developed.

For example, there is disclosed in U.S. Pat. No. 7,211,803 and Japanese Patent Application Laid-Open Publication No. 2009-219538 that when irradiation of a radiation image capturing apparatus starts, electric charges are generated in radiation detection elements 7, the generated electric charges flow out from the radiation detection elements 7 into bias lines 9 (refer to, for example, FIG. 3 described below) connected thereto, and the amount of current flowing in the bias lines 9 increases. Then, it is proposed therein that the bias lines 9 are provided with a current detection unit to detect the current value of the current flowing in the bias lines 9, and start of the irradiation or the like is detected based on the current value.

However, it has been known that the above configuration has some problems. For example, the current detection unit generates noise which has an adverse effect on the amount of electric charges accumulated in the radiation detection elements 7, and the noise which is not always easy to remove is superimposed on the image data D read out from each of the radiation detection elements 7.

The inventors of the present invention et al. carried out various studies to find an alternative method for detecting irradiation by a radiation image capturing apparatus itself, and succeeded to find a method that enables correct detection of irradiation by the radiation image capturing apparatus itself (for example, refer to International Publication No. WO 2011/135917). This new detection method is configured to detect start of irradiation based on data read out by readout circuits 17 before capturing a radiation image. These points are described below.

A control unit of the radiation image capturing apparatus is configured to monitor the data read out by the readout circuits 17 as described above, and detect start of irradiation, for example, when the data (i.e., the value thereof) becomes equal to or greater than a predetermined threshold by irradiation.

Incidentally, according to the studies of the inventors of the present invention et al., when a shock or a vibration is applied to a radiation image capturing apparatus configured as described above, the value of read-out data sometimes abnormally rises.

The cause of this event is not clearly identified, but one of the possible causes is the effect of static electricity accumulated in a circuit board on which radiation detection elements 7 are formed or a circuit board on which a scintillator is formed. Another thereof is vibrations of a flexible circuit board (also called by such a name as Chip On Film, refer to 12 of FIG. 5 described below) made by placing on a film chips such as a readout IC 16 in which readout circuits 17 are built.

Further, it has been known that the value of read-out data sometimes instantaneously and abnormally rise in such a case where static electricity is generated between the radiation image capturing apparatus and the patient's body or cloth or an external device too.

When the value of read-out data rises as described above, start of irradiation may be detected even though the radiation image capturing apparatus in not actually irradiated, namely, start of irradiation is falsely detected.

When such a false detection occurs, as is described below, the radiation image capturing apparatus automatically shifts to an electric charge accumulation state to accumulate electric charges, and carries out an image data D readout process to read out the image data D. Since the radiation image capturing apparatus is not actually irradiated and a subject is not pictured, the read-out image data D is useless. Thus, such a radiation image capturing apparatus has a problem of wasting the amount of power required for the readout process, for example.

The radiation image capturing apparatus has a character that when the radiation image capturing apparatus is irradiated, the value of read-out data stays at a high level, whereas when the radiation image capturing apparatus is vibrated or static electricity is generated therein, the value thereof instantaneously rises but immediately returns to the original low level. Then, there is a case where the radiation image capturing apparatus is configured to detect start of irradiation when the value of data readout in the above manner becomes equal to or greater than a threshold value multiple times in a row.

This configuration makes it possible to certainly prevent false detection of start of irradiation caused by a reason such as the radiation image capturing apparatus being vibrated. However, for a reason described below, a part having decreased values of data appears in a shape of lines in the image data D, that is, the so-called line defect occurs in the image data D read out in the following image data D readout process.

When such a line defect occurs, lines also appear in a radiation image created based on the image data D at a point of the radiation image, the point corresponding to the line defect in the image data D, which causes a problem that the radiation image is difficult to see or the like.

### BRIEF SUMMARY OF THE INVENTION

The present invention is made taking into consideration the above-mentioned points. An objective of the present invention is to provide a radiation image capturing apparatus capable of certainly preventing false detection of start of irradiation caused by reasons such as the radiation image capturing apparatus being vibrated and static electricity being generated therein and also capable of certainly preventing or reducing the line defect to be generated in read-out image data. Another objective of the present invention is to provide a radiation image capturing system using the radiation image capturing apparatus.

In order to achieve at least one of the objectives, according to a first aspect of the present invention, there is provided a radiation image capturing apparatus including: a plurality of scan lines; a plurality of signal lines; a plurality of radiation detection elements arranged two-dimensionally; a scan driving unit which applies ON voltage and OFF voltage to the scan lines, switching the ON voltage and the OFF voltage; switch elements which are connected to the scan lines, and release electric charges accumulated in the radiation detection elements to the signal lines when the ON voltage is applied to the switch elements via the scan lines; readout circuits which read out the electric charges released from the radiation detection elements as image data; and a control unit which (i) alternately carries out (a) a leak data readout process in which the OFF voltage is applied to the scan lines from the scan driving unit so as to set the switch elements to an OFF state, and electric charges leaking from the radiation detection elements via the switch elements in the OFF state are read out as leak data and (b) a reset process of the radiation detection elements, thereby carrying out a detection process to detect start of irradiation of the radiation image capturing apparatus on the basis of the read-out leak data, and (ii) after detecting the start of the irradiation, controls at least the scan driving unit and the readout circuits in such a way that the readout circuits readout the electric charges released from the radiation detection elements as the image data, wherein the control unit, when a value of the leak data read out in the leak data readout process as a first leak data readout process is equal to or greater than a predetermined first threshold, repeats the leak data readout process as a second leak data readout process, skipping the reset process, when a value of the leak data read out in the second leak data readout process is again equal to or greater than the first threshold, detects the start of the irradiation by judging that the irradiation has started, and controls at least the scan driving unit and the readout circuits in such a way that the scan driving unit and the readout circuits carry out processes for when the irradiation has started, and when the value of the leak data readout in the second leak data readout process is smaller than the first threshold, does not detect the start of the irradiation by judging that the irradiation has not started, and alternately carries out the leak data readout process and the reset process again.

In order to achieve at least one of the objectives, according to a second aspect of the present invention, there is provided a radiation image capturing system including: the above-described radiation image capturing apparatus including a communication unit; and a console including a display unit, wherein when not detecting the start of the irradiation, the control unit of the radiation image capturing apparatus transmits to the console the value of the leak data read out in the first leak data readout process with the communication unit, and the console displays the value transmitted from the radiation image capturing apparatus on the display unit with or without converting the value into an indication corresponding to the value.

### BRIEF DESCRIPTION OF THE SEVERAL VIEWS OF THE DRAWING

The present invention is fully understood from the detailed description given hereinafter and the accompanying drawings, which are given byway of illustration only and thus are not intended to limit the present invention, wherein:

FIG. 1 is a sectional view of a radiation image capturing apparatus;

FIG. 2 is a plan view showing the configuration of a circuit board of the radiation image capturing apparatus;

FIG. 3 is a block diagram showing an equivalent circuit of the basic configuration of the radiation image capturing apparatus;

FIG. 4 is a block diagram showing an equivalent circuit of one of pixels constituting a detection unit;

FIG. 5 is a side view illustrating the circuit board to which parts such as a flexible circuit board and PCBs are attached;

FIG. 6 is a timing chart showing timings of ON/OFF of an electric charge reset switch, pulse signals and a TFT in an image data readout process;

FIG. 7 shows a configuration example of the radiation image capturing apparatus according to an embodiment of the present invention built in a radiography room;

FIG. 8 shows a configuration example of the radiation image capturing apparatus according to the embodiment built on a nursing cart;

FIG. 9 illustrates that electric charges leaking from radiation detection elements via TFTs is read as leak data;

FIG. 10 is a timing chart showing timings of ON/OFF of the electric charge reset switch, the pulse signals and the TFT in a leak data readout process to readout the electric charges leaking from the radiation detection elements as the leak data;

FIG. 11 is a graph showing an example of temporal change of the read-out leak data;

FIG. 12 is a timing chart showing timings of ON/OFF of the electric charge reset switch, the pulse signals and the TFTs when the leak data readout process and a reset process of the radiation detection elements are alternately carried out before a radiation image is captured;

FIG. 13 is a timing chart illustrating that in a conventional detection method, even when the value of leak data becomes equal to or greater than a threshold, start of irradiation is not detected at the time, and ON voltage is applied to the next line of scan lines to carry out the reset process;

FIG. 14 illustrates a line defect generated in image data;

FIG. 15 is a timing chart illustrating that in the embodiment, the subsequent reset process is not carried out when the value of the leak data becomes equal to or greater than a threshold, and when the value of leak data read out next is again equal to or greater than the threshold, start of irradiation is detected;

FIG. 16 is a timing chart illustrating that the radiation image capturing apparatus returns to a state for carrying out an irradiation start detection process when start of irradiation is not detected;

FIG. 17 is a timing chart illustrating that the irradiation starts right before or during the reset process right before the leak data readout process in which the value of leak data becomes equal to or greater than the threshold for the first time;

FIG. 18 illustrates the line defect that may be generated in image data generated in the case of FIG. 17;

FIG. 19 illustrates the line defect of two lines in a row is generated in image data;

FIG. 20 is a timing chart illustrating that the timing of the reset process of a line Lm+1 of the scan lines is moved one timing behind because start of irradiation is not detected;

FIG. 21 is a timing chart illustrating that offset data is read out by repeating the same process sequence as the process sequence up to the image data readout process shown in FIG. 20;

FIG. 22 shows a radiation image capturing apparatus having a detection unit divided into multiple areas;

FIG. 23 is a timing chart illustrating that the reset process is carried out by sequentially and alternately shifting the scan lines on a region made up of two of the areas and the scan lines on another region made up of two of the areas, the scan lines to which ON voltage is applied one line by one line, starting from the scan lines on the end parts of the detection unit to the scan lines on the central part of the detection unit;

FIG. 24 is a timing chart illustrating that the reset process is carried out by simultaneously applying ON voltage to two of the scan lines on the different regions and shifting the scan lines to which ON voltage is applied;

FIG. 25 is a timing chart illustrating that timings of the leak data readout process and the reset process are different between the regions and ON voltage is sequentially applied to the scan liens one line by one line;

FIG. 26 is a graph showing an example of temporal change of read-out leak data when the leak data readout process is continued after detection of start of irradiation;

FIG. 27 is a graph illustrating differences between leak data and the threshold;

FIG. 28 is a graph illustrating predetermined ranges set for the differences;

FIG. 29 is a graph illustrating thresholds that define stages into which degrees of attention drawing are classified;

FIG. 30 is a graph illustrating a second threshold and a third threshold set for the value of leak data; and

FIG. 31 is a block diagram showing an equivalent circuit of the basic configuration of a radiation image capturing apparatus provided with a current detection unit.

### DETAILED DESCRIPTION OF THE INVENTION

An embodiment of a radiation image capturing apparatus and a radiation image capturing system according to the present invention is described hereafter with reference to the drawings.

In the following description, the radiation image capturing apparatus is the so-called indirect-type radiation image capturing apparatus provided with, for example, a scintillator and acquires electric signals by converting radiation into light of another wavelength such as visible light. The present invention can also be applied to the so-called direct-type radiation image capturing apparatus which directly detects radiation with radiation detection elements without using parts such as a scintillator.

Although the radiation image capturing apparatus described herein is a portable type, the present invention can also be applied to the so-called specialized type radiation image capturing apparatus which is formed integrally with a support or the like.

### [Radiation Image Capturing Apparatus]

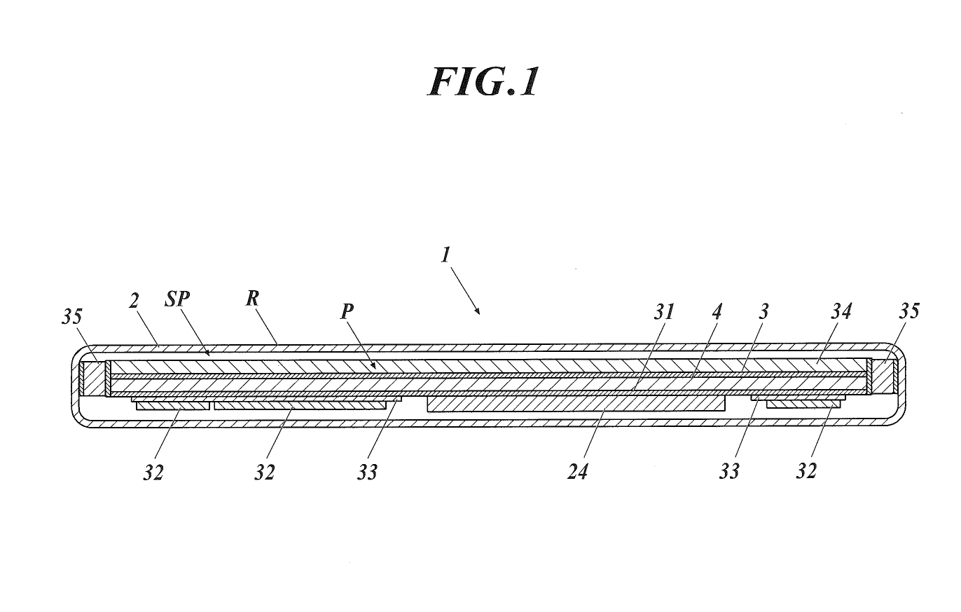

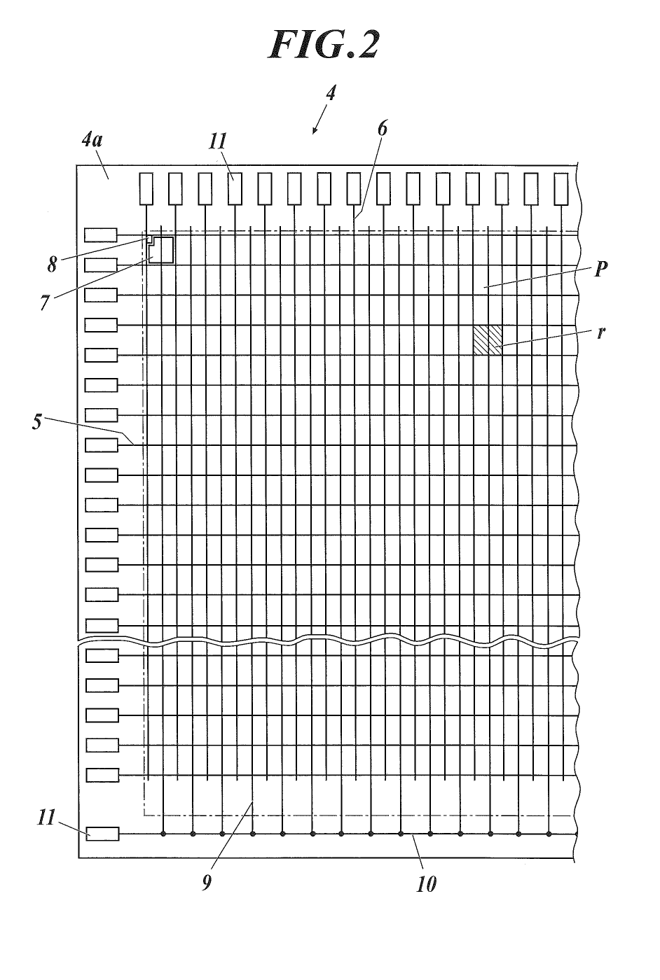

The configuration of a radiation image capturing apparatus according to an embodiment of the invention and other matters are described. FIG. 1 is a sectional view of the radiation image capturing apparatus according to this embodiment, and FIG. 2 is a plan view showing the configuration of a circuit board in the radiation image capturing apparatus.

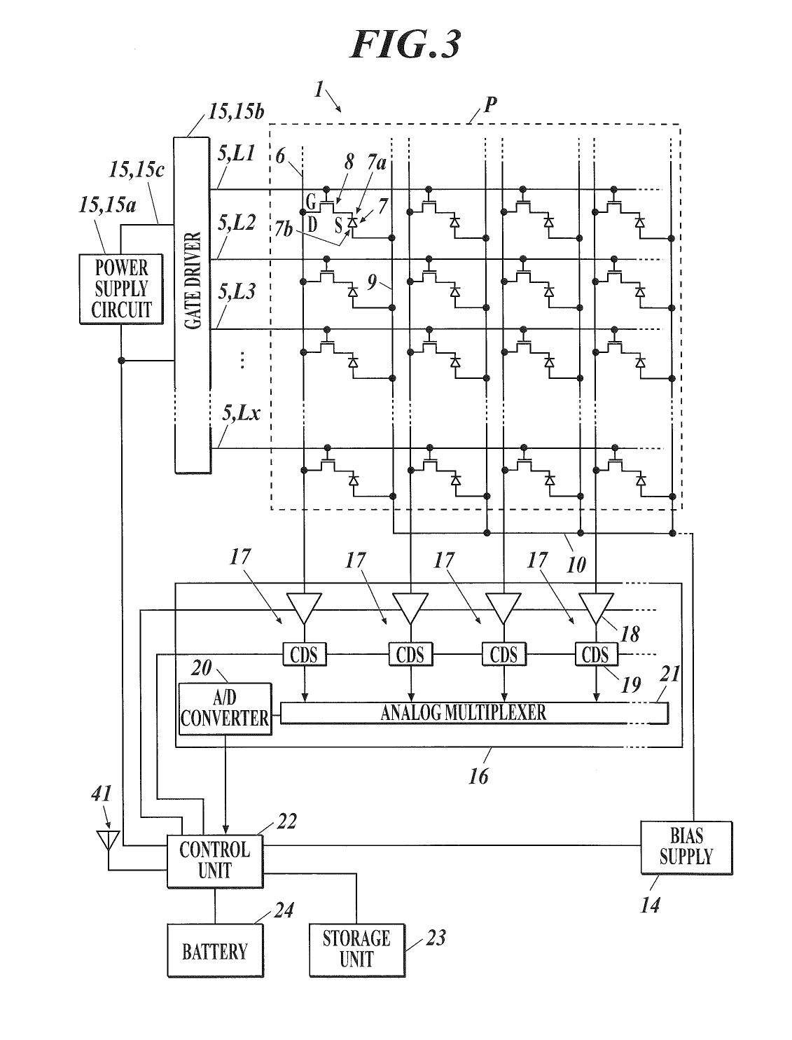

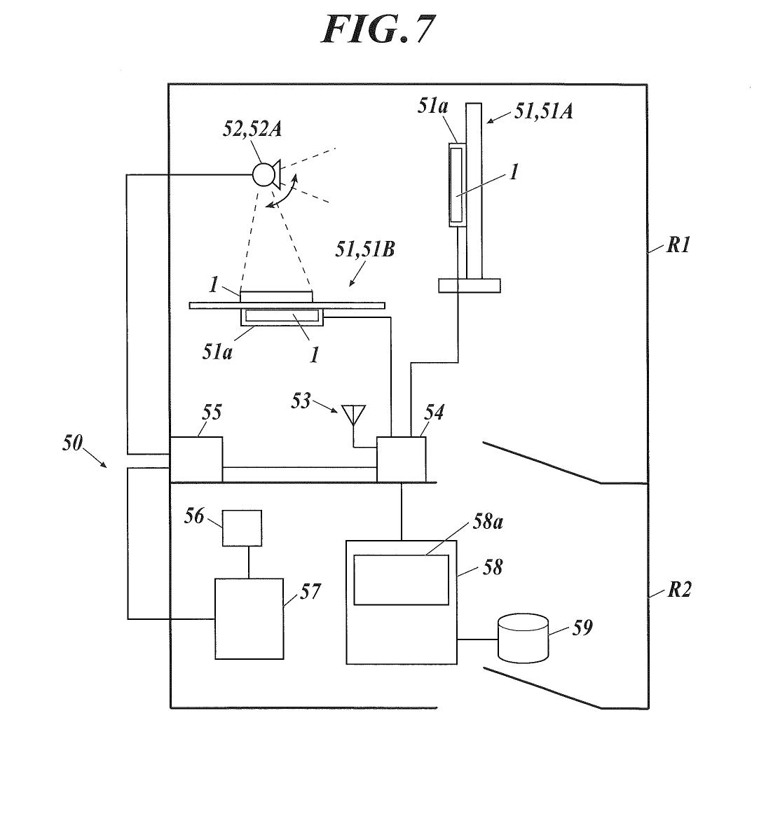

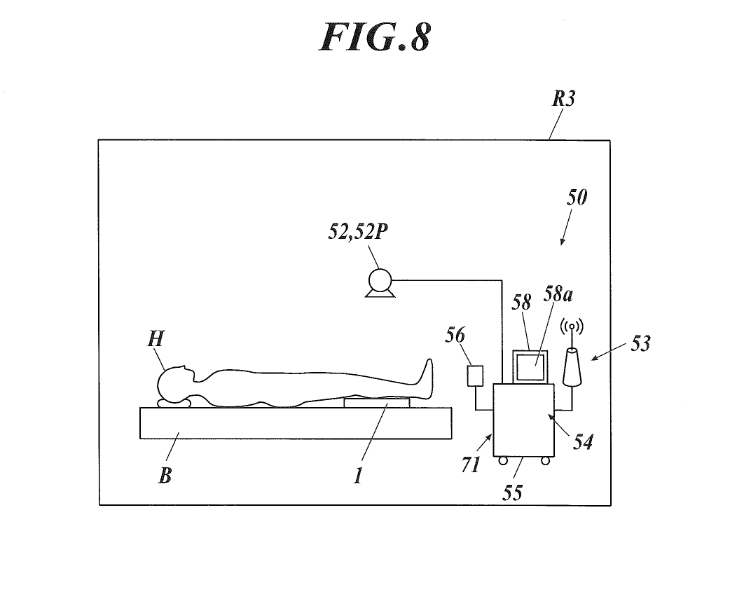

In this embodiment, as shown in FIG. 1, the radiation image capturing apparatus 1 includes a housing 2 having a radiation incidence surface R as a surface on a side that is irradiated and a sensor panel SP placed inside the housing 2. The sensor panel SP includes parts such as a scintillator 3 and a circuit board 4. In addition, although omitted in FIG. 1, in this embodiment, the housing 2 is provided with an antenna device 41 (refer to FIG. 3 described below) as a communication unit to transmit such information as image data D to a console 58 described below (refer to FIG. 7 or 8) by wireless transmission.

Although omitted in FIG. 1, in this embodiment, a connecter is provided on a lateral surface or another part of the housing 2 so that signals, data and the like can be transmitted to, for example, the console 58 via the connecter by wire transmission as well. This connecter functions as a part of the communication unit of the radiation image capturing apparatus 1.

As shown in FIG. 1, a base 31 is provided in the housing 2, and the circuit board 4 is disposed on the radiation incidence surface R side of the base 31 (hereafter simply referred to as the upper surface side or the like in the up-down direction in the drawings) with, for example, a not-shown lead sheet placed between the base 31 and the circuit board 4. On the upper surface side of the circuit board 4, the scintillator 3 which converts received radiation into light such as visible light is placed on a scintillator circuit board 34 and is disposed in such a manner that the scintillator 3 faces the circuit board 4.

On the other hand, parts such as PCBs 33 and a battery 24 are attached to the lower surface of the base 31. Electronic parts 32 are mounted on the PCBs 33. The sensor panel SP is thus constituted by such parts as the base 31 and the circuit board 4. In addition, cushions 35 are provided in the spaces between the sensor panel SP and the lateral surfaces of the housing 2 in this embodiment.

The circuit board 4 is made of a glass substrate in this embodiment. As shown in FIG. 2, a plurality of scan lines 5 and a plurality of signal lines 6 are arranged on the upper surface 4a of the circuit board 4 (i.e., the surface facing the scintillator 3) such that the scan lines 5 and the signal lines 6 intersect with each other. A radiation detection element 7 is provided in each of the small areas r defined by the scan lines 5 and the signal lines 6 on the upper surface 4a of the circuit board 4.

Thus, the whole of the small areas r in which the radiation detection elements 7 are arranged two-dimensionally (in a matrix), one radiation detection element 7 in each one of the small areas r defined by the scan lines 5 and the signal lines 6, forms a detection unit P which is the area defined by the dashed line in FIG. 2. Although a photodiode is used as the radiation detection element 7 in this embodiment, for example, a phototransistor may be used instead.

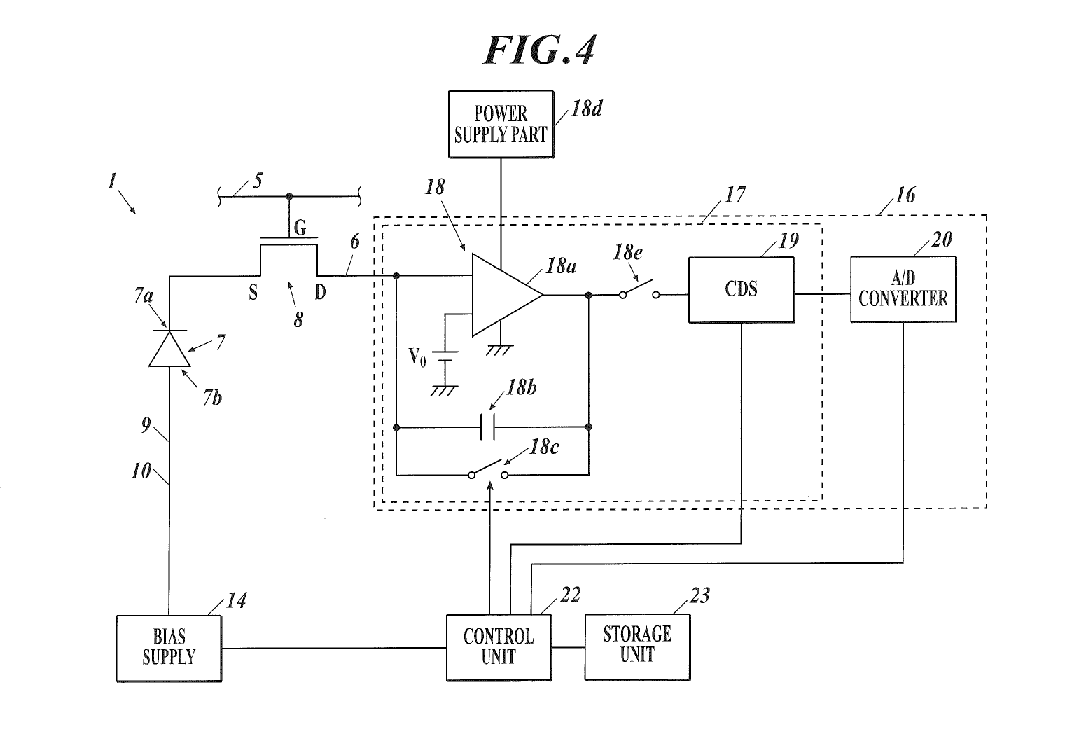

Next, the circuit configuration of the radiation image capturing apparatus 1 is described. FIG. 3 is a block diagram of an equivalent circuit of the radiation image capturing apparatus 1 according to this embodiment. FIG. 4 is a block diagram of an equivalent circuit of one of pixels constituting the detection unit P.

A first electrode 7a of each radiation detection element 7 is connected with a source electrode 8s (refer to “S” in FIG. 3 or 4) of a TFT 8 which is a switch element. A drain electrode 8d and a gate electrode 8g (refer to “D” and “G” in FIG. 3 or 4) of the TFT 8 (TFT8 (L1), for example) are connected with the corresponding signal line 6 and the corresponding scan line 5 (line L1, for example), respectively.

When ON voltage is applied to the gate electrode 8g via the scan line 5 from a scan driving unit 15 described below, the TFT 8 is set to an ON state and releases electric charge accumulated in the radiation detection element 7 to the signal line 6 via the source electrode 8s and the drain electrode 8d. When OFF voltage is applied to the gate electrode 8g via the scan line 5, the TFT 8 is set to an OFF state and stops releasing electric charge from the radiation detection element 7 to the signal line 6 so that electric charge is accumulated in the radiation detection element 7.

In this embodiment, as shown in FIGS. 2 and 3, a bias line 9 is provided for each column of the radiation detection elements 7 on the circuit board 4. A second electrode 7b of each of the radiation detection elements 7 is connected to the bias line 9. The bias lines 9 are bound to a tie line 10 outside the detection unit P of the circuit board 4.

The tie line 10 is connected to a bias supply 14 (refer to FIG. 3 or 4) via an input-output terminal 11 (also called a pad, refer to FIG. 2). Reverse bias voltage is applied to the second electrodes 7b of the radiation detection elements 7 from the bias supply 14 via the tie line 10 and the bias lines 9.

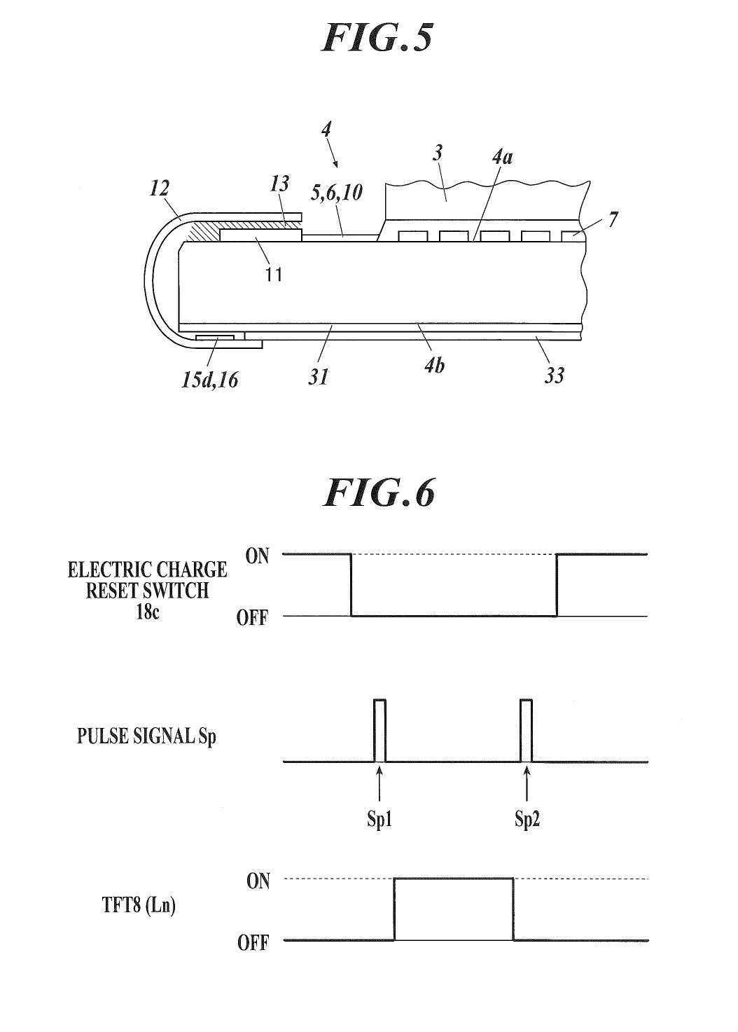

In this embodiment, as shown in FIG. 5, a plurality of input-output terminals 11 is connected to a flexible circuit board 12 via an anisotropic conductive adhesive 13 such as an anisotropic conductive film or an anisotropic conductive paste. The flexible circuit board 12 is made by mounting on a film chips such as a readout IC 16 described below and a gate IC 15d which constitutes the gate driver 15b of the scan driving unit 15.

The flexible circuit board 12 is curved and pulled to a lower surface 4b side of the circuit board 4 and connected to the above-described PCBs 33 on the lower surface 4b side. The sensor panel SP of the radiation image capturing apparatus 1 is thus formed. In FIG. 5, parts such as the electronic parts 32 are omitted.

The scan lines 5 are connected to the gate driver 15b of the scan driving unit 15 via their respective input-output units 11. In the scan driving unit 15, ON voltage and OFF voltage are supplied to the gate driver 15b from a power supply circuit 15a via wiring 15c, and the voltage applied to the lines L1 to Lx of the scan lines 5 can be switched between ON voltage and OFF voltage by the gate driver 15b.

The signal lines 6 are each connected to one of the readout circuits 17 built in the readout IC 16 via their respective input-output terminals 11. In this embodiment, each readout circuit 17 is mainly composed of parts such as an amplifier circuit 18 and a correlated double sampling circuit 19. An analog multiplexer 21 and an A/D converter 20 are also provided in the readout IC 16. In FIGS. 3 and 4, the correlated double sampling circuit 19 is denoted as “CDS”.

In this embodiment, the amplifier circuit 18 is a charge amplifier circuit including an operational amplifier 18a, a capacitor 18b, an electric charge reset switch 18c and a power supply part 18d. The capacitor 18b and the electric charge reset switch 18c are connected in parallel with the operational amplifier 18a, and the power supply part 18d supplies power to the operational amplifier 18a and other parts. The inverting input terminal on the input side of the operational amplifier 18a of the amplifier circuit 18 is connected with the corresponding signal line 6.

The electric charge reset switch 18c of the amplifier circuit 18 is connected with a control unit 22 so that ON/OFF of the electric charge reset switch 18c is controlled by the control unit 22. In this embodiment, a switch 18e that opens and closes in coordination with the electric charge reset switch 18c is provided between the operational amplifier 18a and the correlated double sampling circuit 19. The switch 18e changes its OFF/ON in coordination with ON/OFF of the electric charge reset switch 18c.

In the image data D readout process from the radiation detection elements 7, as shown in FIG. 6, when the electric charge reset switches 18c of the amplifier circuits 18 are in the OFF state, and ON voltage is applied to the TFTs 8 of the radiation detection elements 7 to set the TFTs 8 to the ON state, electric charge is released to the signal lines 6 from the radiation detection elements 7, flows into the capacitors 18b of the amplifier circuits 18 in the readout circuits 17, and is accumulated in the capacitors 18b. Then, in each amplifier circuit 18, a voltage value corresponding to the amount of electric charge accumulated in the capacitor 18b is output from the output side of the operational amplifier 18a.

The correlated double sampling circuit 19 outputs to the downstream an increment between values output from the amplifier circuit 18 before and after electric charge flows therein from the radiation detection element 7 as analog value image data D. The output image data D are sequentially sent to the A/D converter 20 via the analog multiplexer 21. The received image data D are sequentially converted into digital value image data D by the A/D converter 20 and output to the storage unit 23 so as to be sequentially stored therein. The image data D readout process is thus carried out.

The control unit 22 is constituted, for example, by a computer or an FPGA (Field Programmable Gate Array). The computer includes parts such as a CPU (Central Processing Unit), a ROM (Read Only Memory), a RAM (Random Access Memory) and an input-output interface which are connected to a bus (all not shown). The control unit 22 may be constituted by a specialized control circuit.

The control unit 22 controls the operation and the like of functional parts of the radiation image capturing apparatus 1. For example, the control unit 22 controls the scan driving unit 15 and the readout circuits 17 so as to carry out the above-described image data D readout process. Further, as shown in FIGS. 3 and 4, the control unit 22 is connected with the storage unit 23 including, for example, an SRAM (Static RAM) or an SDRAM (Synchronous DRAM).

In addition, in this embodiment, the control unit 22 is connected with the aforementioned antenna device 41 and the battery 24 that supplies required power to the functional parts such as the scan driving unit 15, the readout circuits 17, the storage unit 23 and the bias supply 14.

### [Radiation Image Capturing System]

Next, the configuration of a radiation image capturing system 50 using the radiation image capturing apparatus 1 according to this embodiment and other matters are described. FIG. 7 shows a configuration example of the radiation image capturing system 50 according to this embodiment. In FIG. 7, the radiation image capturing system 50 is built, for example, in a radiography room R1.

Bucky devices 51 are provided in the radiography room R1. Each of the Bucky devices 51 can hold the radiation image capturing apparatus 1 by a cassette holder 51a. Although a standing X-ray Bucky device 51A and a supine X-ray Bucky device 51B are provided as Bucky devices 51 in FIG. 7, for example, only one of the Bucky devices 51 may be provided.

As shown in FIG. 7, the radiography room R1 is provided with at least one radiation source 52A that emits radiation to irradiate the radiation image capturing apparatus 1 set on the Bucky device 51 through a subject. In this embodiment, both the standing X-ray Bucky device 51A and the supine X-ray Bucky device 51B can be irradiated by the radiation source 52A by moving the radiation source 52A or changing the direction of the radiation.

The radiography room R1 is provided with a relay 54 (also called a base station or by another name) to relay communication and the like between devices inside and outside the radiography room R1. In this embodiment, the relay 54 is provided with an access point 53 so that the radiation image capturing apparatus 1 can transmit and receive the image data D, signals and the like by wireless transmission.

In addition, the relay 54 is connected with a radiation generation apparatus 55 and the console 58. In the relay 54, a not-shown converter is built which converts LAN (Local Area Network) signals or the like transmitted from, for example, the radiation image capturing apparatus 1 or the console 58 to the radiation generation apparatus 55 into signals or the like for the radiation generation apparatus 55 and vice versa.

In a front room R2 (also called an operation room or by another name) of this embodiment, an operator console 57 for the radiation generation apparatus 55 is provided. The operator console 57 has an exposure switch 56 which is operated by an operator such as a radiological technologist to command the radiation generation apparatus 55 to carry out operations such as starting irradiation. When the exposure switch 56 is operated by an operator, the radiation generation apparatus 55 emits radiation from the radiation source 52. In addition, the radiation generation apparatus 55 carries out various controls such as controlling the radiation source 52 to emit an appropriate radiation dose of radiation.

As shown in FIG. 7, the console 58 constituted by a computer or the like is provided in the front room R2 in this embodiment. The console 58 can be placed at any appropriate place, for example, in the radiography room R1, outside the front room R2 or in another room.

The console 58 has a display unit 58a which includes a CRT (Cathode Ray Tube), an LCD (Liquid Crystal Display) or the like and a not-shown input unit such as a mouse or a key board. The console 58 is connected with or includes a storage unit 59 constituted by an HDD (Hard Disk Drive) or the like.

As shown in FIG. 8, the radiation image capturing apparatus 1 can also be used alone without being set on the Bucky device 51. For example, when a patient H cannot stand up from a bed B in a patient's room. R3 and cannot go to the radiography room R1, as shown in FIG. 8, the radiation image capturing apparatus 1 can be carried into the patient's room R3 and inserted between the bed B and the patient's body or placed on the patient's body.

In this case, as shown in FIG. 8, the so-called portable radiation generation apparatus 55 is carried into the patient's room R3 by, for example, mounting the radiation generation apparatus 55 on a nursing cart 71. A radiation source 52P of the portable radiation generation apparatus 55 can emit radiation in a desired direction. Thus, it is possible to irradiate the radiation image capturing apparatus 1 placed, for example, between the bed B and the patient's body from an appropriate distance and an appropriate direction.

In this case, the radiation generation apparatus 55 is provided with a built-in relay 54 having an access point 53. Similarly to the above case, the relay 54 relays, for example, communication between the radiation generation apparatus 55 and the console 58 and communication and transmission of the image data D between the radiation image capturing apparatus 1 and the console 58.

As shown in FIG. 7, the radiation image capturing apparatus 1 can also be inserted between the body of a not-shown patient laying on the supine X-ray Bucky device 51B in the radiography room R1 and the supine X-ray Bucky device 51B, or be placed on the patient's body on the supine X-ray Bucky device 51B. In these cases, either the portable radiation source 52P or the fixed radiation source 52A in the radiography room R1 can be used.

In this embodiment, the console 58 also functions as an image processing unit. Receiving the image data D or other information from the radiation image capturing apparatus 1, based on the data, the console 58 carries out accurate image processing such as offset correction, gain correction, defective pixel correction or gradation processing suitable for an image-captured site of the body of a subject. A radiation image is thereby created.

### [Irradiation Start Detection Method]

Next, the basic configuration of an irradiation start detection method used in the radiation image capturing apparatus 1 according to this embodiment is described.

In this embodiment, as described above, an interface is not built between the radiation image capturing apparatus 1 and the radiation generation apparatus 55 (refer to FIG. 7 or 8), and the radiation image capturing apparatus 1 is configured to detect radiation emitted from a radiation source of a radiation generation apparatus by itself. As an irradiation start detection method, for example, the aforementioned detection method disclosed in International Publication No. WO 2011/135917 can be adopted. This detection method is described in the following. The above-mentioned document should be referred to for details of this detection method.

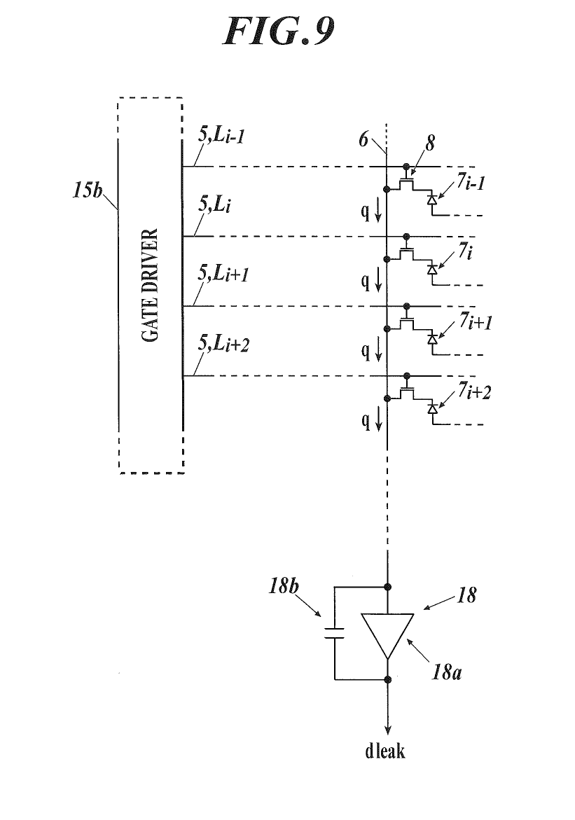

In this detection method, the control unit 22 of the radiation image capturing apparatus 1 repeatedly carries out a leak data dleak readout process before capturing a radiation image. As shown in FIG. 9, leak data dleak is data that corresponds to the sum of electric charges q leaking from the radiation detection elements 7 of one signal line 6 via the TFTs 8 set in the OFF state by applying OFF voltage to the scan lines 5.

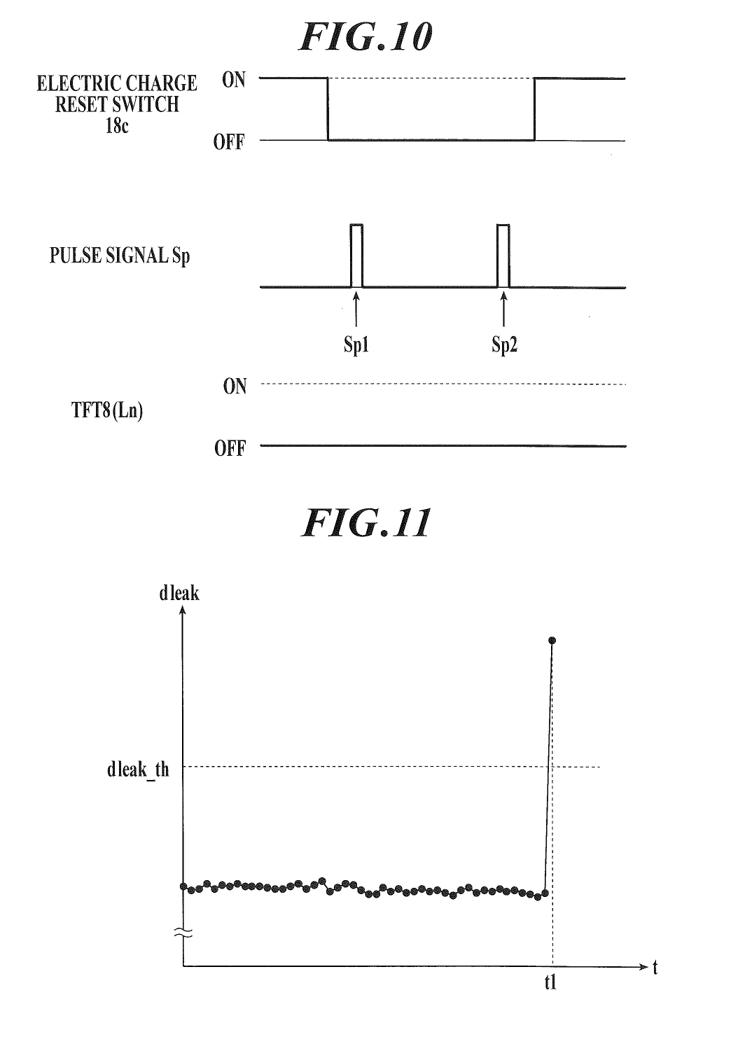

In the leak data dleak readout process, as shown in FIG. 10, when OFF voltage is applied to the lines L1 to Lx of the scan lines 5 and accordingly the TFTs 8 are set to the OFF state, pulse signals Sp1 and Sp2 are sent from the control unit 22 to the correlated double sampling circuit 19 of the readout circuit 17 (refer to the CDS in FIG. 3 or 4) and the leak data dleak is read out.

Different from the image data D readout process (refer to FIG. 6), in the leak data dkeak readout process, ON voltage is not applied to the scan lines 5 from the gate driver 15b. From the time the pulse signal Sp1 is transmitted from the control unit 22 to the correlated double sampling circuit 19 to the time the pulse signal Sp2 is transmitted from the control unit 22 to the correlated double sampling circuit 19, electric charges q leaking from the radiation detection elements 7 via the TFTs 8 are accumulated in the capacitor 18b of the amplifier circuit 18. Thus, the sum of the electric charges q of each signal line 6 is read out as the leak data dleak.

With the configuration in which the leak data dleak is read out as described above, when irradiation of the radiation image capturing apparatus 1 starts, the TFTs 8 are irradiated with light converted from radiation by the scintillator 3 (refer to FIG. 1). A study of the inventors et al. revealed that the electric charges q leaking from the radiation detection elements 7 via the TFTs 8 (refer to FIG. 9) thereby increased.

As described above, the electric charges q leaking from the radiation detection elements 7 via the TFTs 8 increase when the radiation image capturing apparatus 1 is irradiated. Therefore, as shown in FIG. 11, the value of the read-out leak data dleak are greater than the values of the leak data dleak read out before irradiation (refer to time t1 in FIG. 11). Thus, in this detection method, the value of the leak data dleak read out changes when the radiation image capturing apparatus 1 is irradiated.

This embodiment utilizes this character. As shown in FIG. 11, for example, a threshold (first threshold) dleak_th is set for the leak data dleak in this embodiment. Start of irradiation of the radiation image capturing apparatus 1 is detected at the time when the value of the read-out leak data dleak becomes equal to or greater than the threshold dleak_th.

Incidentally, as described above, the leak data dleak readout process is carried out while the TFTs 8 are in the OFF state in this detection method. If the TFTs 8 are kept in the OFF state, dark electric charges (also called dark current or by another name) generated in the radiation detection elements 7 continue to be accumulated therein.

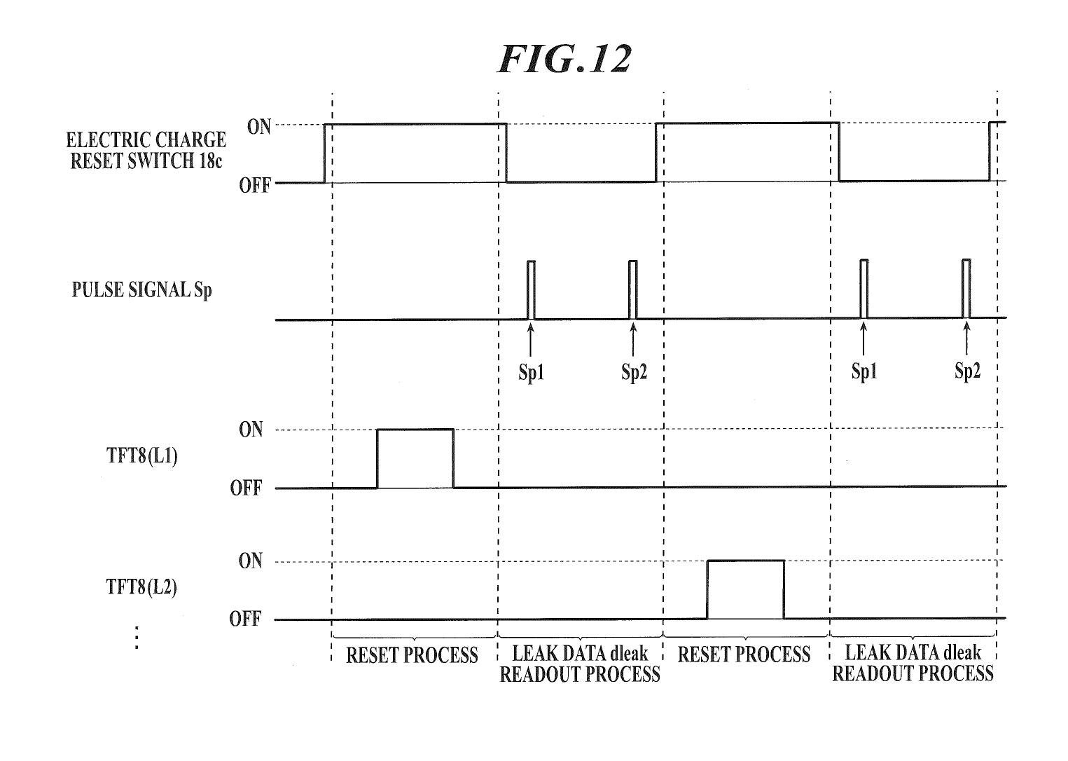

Hence, if this detection method is adopted, normally a reset process of the radiation detection elements 7 is carried out between a leak data dleak readout process and the next leak data dleak readout process. In other words, as shown in FIG. 12, normally the leak data dleak readout process and the reset process of the radiation detection elements 7 are alternately carried out in this detection method.

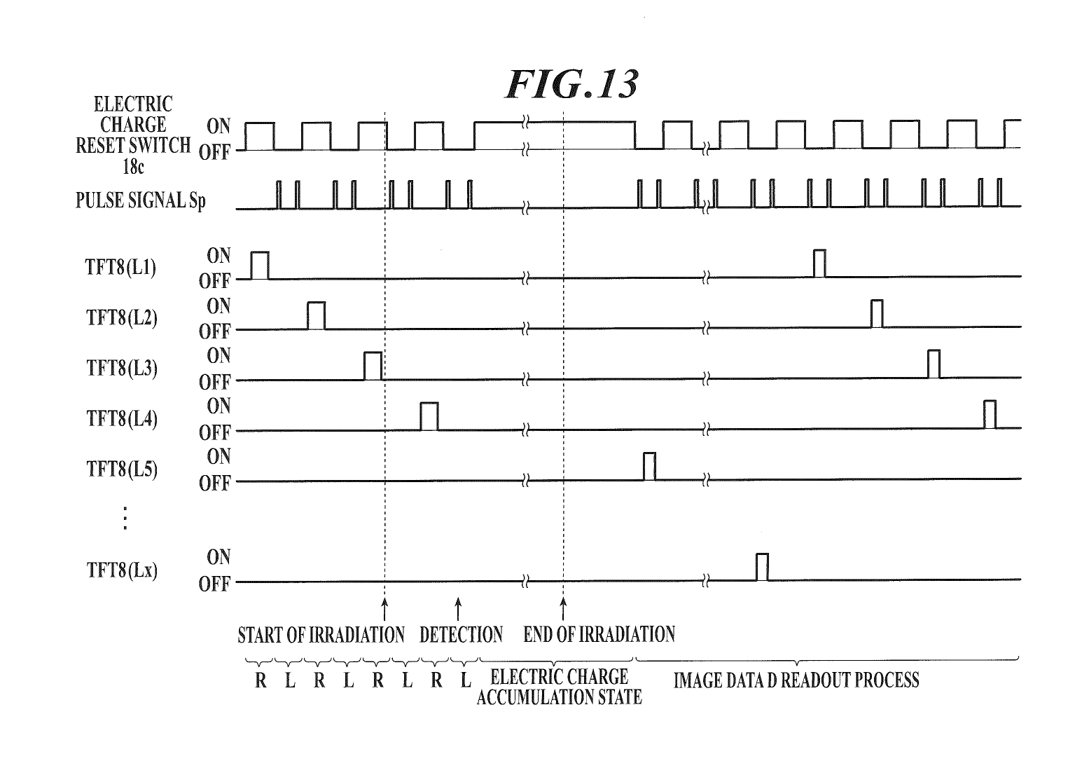

As shown in FIG. 13, the reset process of the radiation detection elements 7 is carried out by sequentially applying ON voltage to the lines L1 to Lx of the scan lines 5 from the gate driver 15b of the scan driving unit 15.

### [Configuration for Preventing False Detection of Start of Irradiation Due to Vibration, Etc.]

Next, the configuration of the radiation image capturing apparatus 1 to certainly prevent false detection of start of irradiation thereof caused by such a reason as the apparatus 1 being vibrated and other matters are described.

As described above, when irradiation of the radiation image capturing apparatus 1 starts, as shown in FIG. 11, the value of the read-out leak data dleak becomes significantly larger than the value of the leak data dleak read out before irradiation. The value of the read-out leak data dleak also rises significantly, for example, when the radiation image capturing apparatus 1 is vibrated or static electricity is generated therein.

However, as described above, when the radiation image capturing apparatus 1 is irradiated, the value of the leak data dleak stays at the high level once the value rises, whereas, for example, when the radiation image capturing apparatus 1 is vibrated or static electricity is generated therein, the value of the leak data dleak instantaneously rises but immediately returns to the original low level.

Then, as a method for preventing false detection of start of the irradiation caused by such a reason as the radiation image capturing apparatus 1 being vibrated, for example, start of the irradiation may be detected when the value of the leak data dleak read out in the above-described manner is equal to or greater than the threshold dleak_th (refer to FIG. 11) two times in a row.

For example, if the value of the leak data dleak read out in the first leak data dleak readout process is equal to or greater than the threshold dleak_th and the value of the leak data dleak read out in the second (next) leak data dleak readout process is again equal to or greater than the threshold dleak_th, the control unit 22 judges that irradiation of the radiation image capturing apparatus 1 has started.

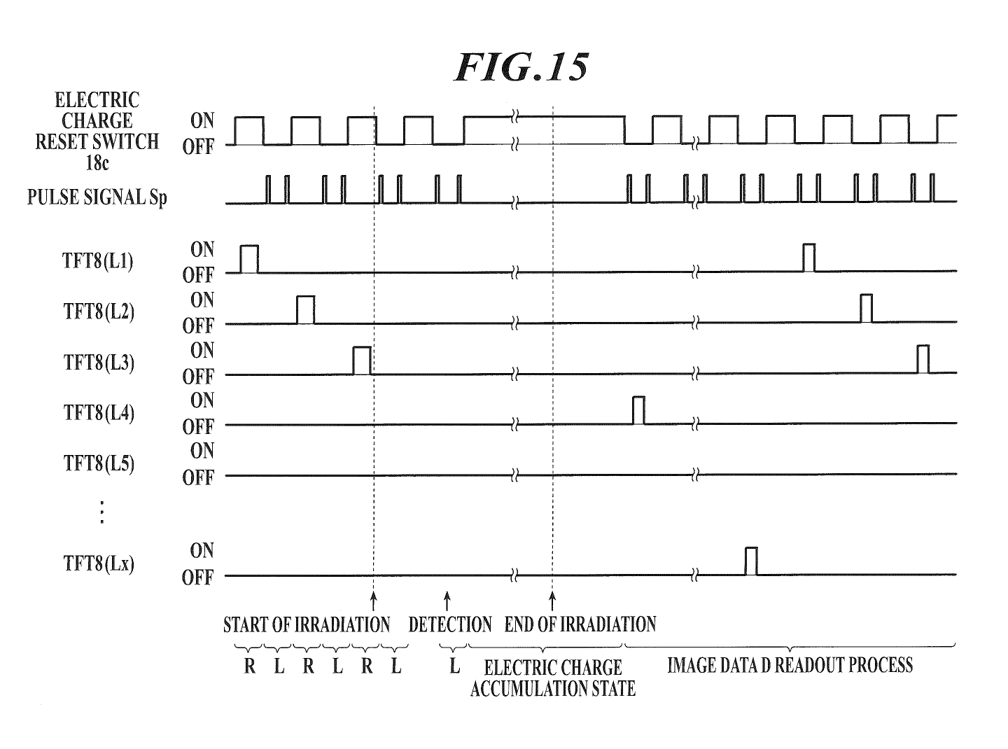

In this case, the control unit 22 of the radiation image capturing apparatus 1 judges that the irradiation has started and, as shown in FIG. 15 described below, controls the gate driver 15b of the scan driving unit 15 to apply OFF voltage to the lines L1 to Lx of the scan lines 5 so as to set the TFTs 8 to the OFF state, thereby shifting to the electric charge accumulation state.

After a predetermined time, the control unit 22 controls the gate driver 15b thereof to sequentially apply ON voltage to the lines L1 to Lx of the scan lines 5, and commands the functional parts to carry out the processes for when the irradiation has started. For example, the control unit 22 activates the readout circuits 17 so that the readout circuits 17 read out the image data D from the radiation detection elements 7, thereby carrying out the image data D readout process.

On the other hand, for example, if the value of the leak data dleak read out in the first leak data dleak readout process is equal to or greater than the threshold dleak_th but the value of the leak data dleak read out in the next leak data dleak readout process is smaller than the threshold dleak_th, the control unit 22 judges that the irradiation has not started yet by judging that the value thereof read out in the first leak data dleak readout process is due to, for example, the radiation image capturing apparatus 1 being vibrated. That is, the control unit 22 does not detect start of irradiation. Then, the radiation image capturing apparatus 1 returns to the state for carrying out an irradiation start detection process. That is, the radiation image capturing apparatus 1 returns to the state for alternately carrying out the leak data dleak readout process and the reset process of the radiation detection elements 7.

Thus, when irradiation of the radiation image capturing apparatus 1 starts, the control unit 22 can detect start of the irradiation accurately, and shift to the state for carrying out processes for capturing a radiation image accurately. In addition, false detection of start of irradiation caused by, for example, the radiation image capturing apparatus 1 being vibrated or static electricity being generated therein can be certainly prevented. Consequently, the control unit 22 can accurately return to the original state for carrying out the irradiation start detection process.

### [Adverse Effect of the Configuration for Preventing False Detection of Start of Irradiation Due to Vibration, Etc.]

Next, an adverse effect caused by the radiation image capturing apparatus 1 adopting the above configuration for preventing false detection of start of irradiation due to such a reason as the apparatus 1 being vibrated or static electricity being generated therein is described. The following adverse effect may be caused when the above configuration is adopted.

As described above, the leak data dleak readout process and the reset process of the radiation detection elements 7 are alternately carried out in the irradiation start detection method described above. In the above configuration, even when irradiation of the radiation image capturing apparatus 1 actually starts and the value of the read-out leak data dleak becomes equal to or greater than the threshold dleak_th, start of the irradiation is not detected at the time, and the reset process of the radiation detection elements 7 is carried out.

That is, for example, as shown in FIG. 13, even if the value of the leak data dleak read out in the leak data dleak readout process after the reset process of the radiation detection elements 7 which is carried out by ON voltage being applied to the line L3 of the scan lines 5 becomes equal to or greater than the threshold dleak_th, start of the irradiation is not detected at the time, and the reset process of the radiation detection elements 7 is carried out by ON voltage being applied to the next line L4 of the scan lines 5.

If the leak data dleak read out in the next leak data dleak readout process is again equal to or greater than the threshold dleak_th, start of the irradiation is then detected. Incidentally, “R” and “L” in the drawings such as FIG. 13 and FIG. 15 described below represent the reset process of the radiation detection elements 7 and the leak data dleak readout process, respectively.

Thus, with this configuration, in the case where the radiation image capturing apparatus 1 is actually irradiated, the reset process of the radiation detection elements 7 is carried out at least once (in the above example, ON voltage is applied to the line L4 of the scan lines 5) after the value of the read-out leak data dleak becomes equal to or greater than the threshold dleak_th in response to the start of the irradiation.

That is, after the irradiation starts, the reset process is carried out at least once on the radiation detection elements 7 connected to the line L4 of the scan lines 5 via the TFTs 8, the radiation detection elements 7 in which effective electric charges are generated by irradiation. Therefore, the effective electric charges generated by irradiation is once removed from those radiation detection elements 7 by the reset process, and electric charges newly generated thereafter by irradiation are accumulated in the radiation detection elements 7.

Therefore, some electric charge readout as the image data D from each of those radiation detection elements 7, that is, the radiation detection elements 7 connected to the line L4 of the scan lines 5 in the above example, is lost as described above. The data value of the image data D read out from each radiation detection element 7 is smaller than the data value that should actually have been read out.

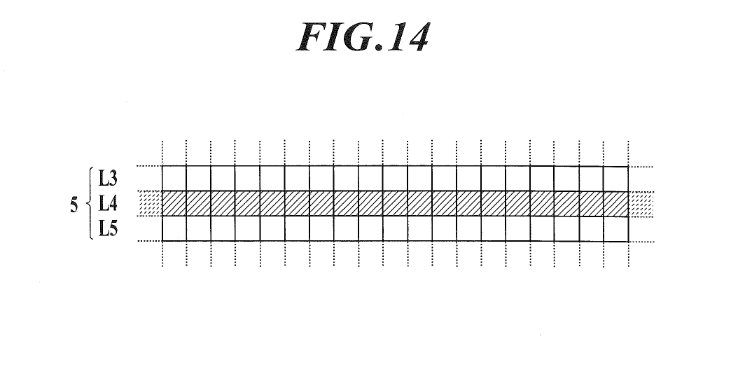

Accordingly, in the image data D readout process (refer to FIG. 13) carried out later, among the image data D read out from the radiation detection elements 7 including those radiation detection elements 7, the image data D corresponding to those radiation detection elements 7 (in the above example, the image data D corresponding to the radiation detection elements 7 connected to the line L4 of the scan lines 5) have decreased data values, and accordingly the so-called line defect (refer to the hatched part of FIG. 14) is generated therein.

When the line defect is generated, a line or lines also appears in a radiation image created based on the image data D at a point corresponding to the line defect in the image data D. This may make the radiation image difficult to see. Further, when the line defect is corrected, information captured at the part of the line defect may disappear from the radiation image by the image correction.

### [Configuration for Preventing Generation of Line Defect, Etc.]

To prevent generation of the line defect, the radiation image capturing apparatus 1 according to this embodiment is configured as follows. The operation of the radiation image capturing apparatus 1 according to this embodiment is also described in the following.

In this embodiment, as described above, the control unit 22 of the radiation image capturing apparatus 1 alternately carries out the leak data dleak readout process and the reset process of the radiation detection elements 7 before capturing a radiation image.

The configuration is the same as the above-described configuration in that the control unit 22 does not immediately judge that the irradiation has started even when the value of the leak data dleak read out in the leak data dleak readout process of a certain time becomes equal to or greater than the threshold dleak_th. However, the configuration is different from the above-described configuration in that the control unit 22 does not carry out the subsequent reset process of the radiation detection elements but carries out the leak data dleak readout process again when the value of the read-out leak data dleak becomes equal to or greater than the threshold dleak_th.

For example, as shown in FIG. 15, when the control unit 22 carries out the reset process of the radiation detection elements 7 by applying ON voltage to the line L3 of the scan lines 5 and the value of the leak data dleak read out in the subsequent leak data dleak readout process becomes equal to or greater than the threshold dleak_th, the control unit 22 does not judge that the irradiation has started at the time. The control unit 22 does not carryout the subsequent reset process of the radiation detection elements 7 by applying ON voltage to, in this case, the subsequent line L4 of the scan lines 5.

Then, as shown in FIG. 15, without carrying out the reset process of the radiation detection elements 7, that is, without applying ON voltage to the next line L4 of the scan lines 5, the control unit 22 carries out the leak data dleak readout process at the next timing of the leak data dleak readout process. When the value of the leak data dleak read out in the next leak data dleak readout process is again equal to or greater than the threshold dleak_th, the control unit 22 then judges that the irradiation has started, thereby detecting start of the irradiation, and commands the functional parts to carryout the processes for when the irradiation has started, namely, the processes carried out after start of the irradiation is detected.

More specifically, as shown in FIG. 15, when start of the irradiation is detected in the above manner, the control unit 22 controls the gate driver 15b to apply OFF voltage to all of the lines L1 to Lx of the scan lines 5 so as to set the TFTs 8 to the OFF state, thereby shifting to the electric charge accumulation state in which electric charges generated by irradiation in the radiation detection elements 7 are accumulated in the radiation detection elements 7.

The control unit 22 carries out the image data D readout process, for example, after keeping the electric charge accumulation state for a predetermined time from the time start of the irradiation is detected.

In this embodiment, as shown in FIG. 15, the control unit 22 carries out the image data D readout process by subsequently applying ON voltage from the gate driver 15b to the scan lines 5 starting from the scan line 5 to which ON voltage has been scheduled to be applied (in the case of FIG. 15, the line L4 of the scan lines 5) next to the scan line 5 to which ON voltage has been applied last before detecting start of the irradiation (in the case of FIG. 15, the line L3 of the scan lines 5).

After finishing the image data D readout process in the above manner, the control unit 22 acquires offset data O.

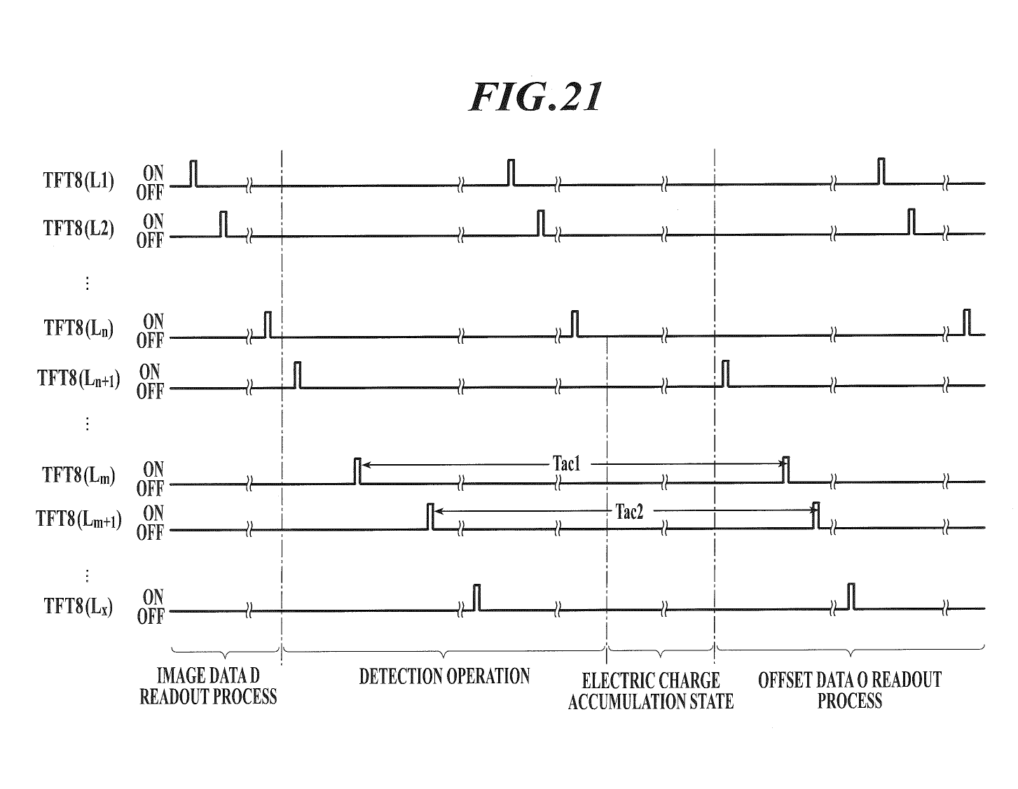

Although omitted in FIG. 15, the control unit 22 of this embodiment acquires the offset data O by carrying out the same process sequence as the process sequence to the image data D readout process shown in FIG. 13 (refer to FIG. 21 described below).

That is, after finishing the image data D readout process, in the case of the above detection method, the control unit 22 alternately carries out the leak data dleak readout process and the reset process of the radiation detection elements 7 for a certain number of times (with no irradiation), shifts to the electric charge accumulation state, and then carries out the image data D readout process (i.e., an offset data O readout process) to acquire the offset data O.

After finishing the offset data O readout process which corresponds to the image data D readout process, the control unit 22 transmits the image data D and the offset data O read out from each radiation detection element 7 to an image processing apparatus, for example, the console 58 (refer to FIG. 7 or 8). The radiation image capturing apparatus 1 may also transmit data for a preview image to the console 58 at an appropriate timing.

On the other hand, when the control unit 22 carries out the reset process of the radiation detection elements 7 by applying ON voltage to the line L3 of the scan lines 5 and the value of the leak data dleak read out in the subsequent leak data dleak readout process becomes equal to or greater than the threshold dleak_th but, with no subsequent reset process of the radiation detection elements 7 carried out by applying ON voltage to, in this case, the next line L4 of the scan lines 5, the value of the leak data dleak read out at the next timing of the leak data dleak readout process is smaller than the threshold dleak_th, the control unit 22 judges that the irradiation has not started yet, thereby not detecting start of the irradiation.

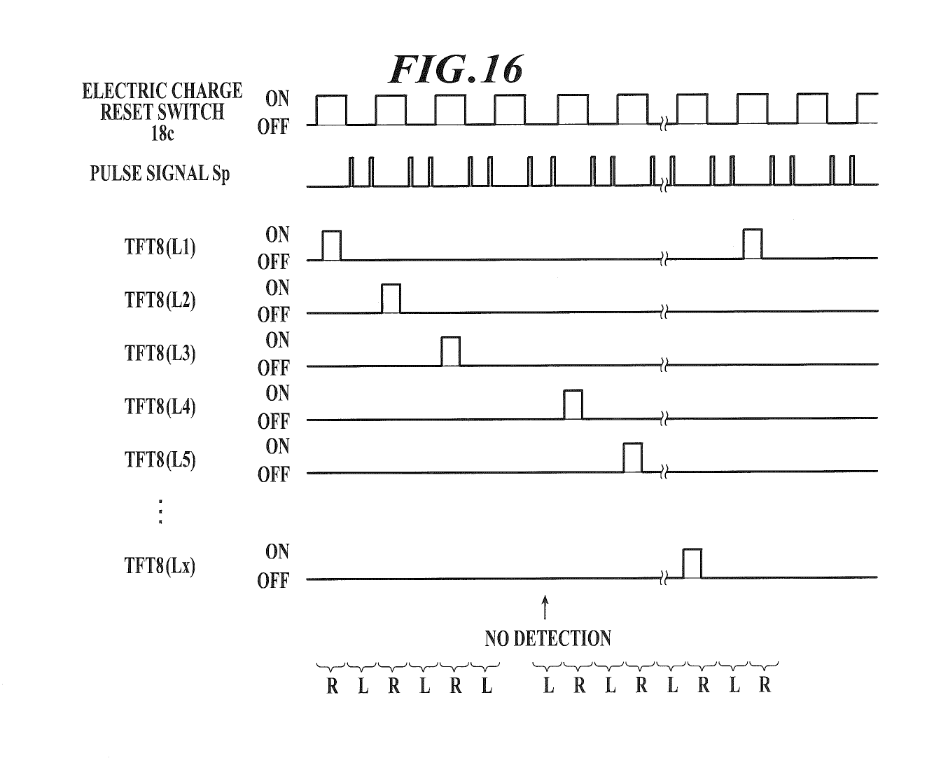

In this case, as shown in FIG. 16, the control unit 22 restarts the reset process of the radiation detection elements 7 right after finding that the value of the read-out leak data dleak is smaller than the threshold dleak_th and judging that the irradiation has not started yet. That is, the control unit 22 returns to the state for alternately carrying out the leak data dleak readout process and the reset process of the radiation detection elements 7.

With the above configuration, as described above, on the basis of whether or not the value of the leak data dleak is again equal to or greater than the threshold dleak_th in the leak data dleak readout process next to the leak data dleak readout process in which the value of the leak data dleak becomes equal to or greater than the threshold dleak_th for the first time, whether or not irradiation of the radiation image capturing apparatus 1 has started can be correctly judged, that is, start of the irradiation can be correctly detected.

If the value of the leak data dleak that is once equal to or greater than the threshold dleak_th is again equal to or greater than the threshold dleak_th in the subsequent leak data dleak readout process, the control unit 22 can correctly judge that irradiation of the radiation image capturing apparatus 1 has started, and appropriately command the functional parts such as the scan driving unit 15 and the readout circuits 17 to carry out the processes for when the irradiation has started so as to correctly read out the image data D from each radiation detection element 7.

If the value of the leak data dleak that is once equal to or greater than the threshold dleak_th is smaller than the threshold dleak_th in the subsequent leak data dleak readout process, the control unit 22 can correctly judge that irradiation thereof has not started yet by judging that the value thereof being equal to or greater than the threshold dleak_th is due to, for example, the radiation image capturing apparatus 1 being vibrated or static electricity being generated therein. Then, the control unit 22 can accurately return to the state for carrying out the irradiation start detection process.

In this embodiment, when the value of the leak data dleak read out in the first leak data dleak readout process is equal to or greater than the threshold dleak_th, as shown in FIG. 15 and other drawings, the subsequent reset process of the radiation detection elements 7 (in the case of FIG. 15 or the like, the reset process of the radiation detection elements 7 carried out by applying ON voltage to the line L4 of the scan lines 5) is not carried out.

Because the subsequent reset process of the radiation detection elements 7 is not carried out when the radiation image capturing apparatus 1 is irradiated and consequently the value of the read-out leak data dleak becomes equal to or greater than the threshold dleak_th, the effective electric charges which are generated by irradiation in the radiation detection elements 7 and accumulated therein can be prevented from being lost by the reset process.

Accordingly, it is possible to prevent the line defect as that shown in FIG. 14 from being generated in the image data D which is read out from each radiation detection element 7 in the following image data D readout process (refer to FIG. 15).

In FIG. 15, irradiation of the radiation image capturing apparatus 1 starts after the reset process is carried out by applying ON voltage to the line L3 of the scan lines 5.

In this case, the value of the leak data dleak read out in the leak data dleak readout process right after the reset process carried out by applying ON voltage to the line L2 of the scan lines 5 is smaller than the threshold dleak_th because the value is a value before start of the irradiation. Meanwhile, the value of the leak data dleak read out in the leak data dleak readout process right after the reset process carried out by applying ON voltage to the line L3 of the scan lines 5 is equal to or greater than the threshold dleak_th because the value is a value after start of the irradiation.

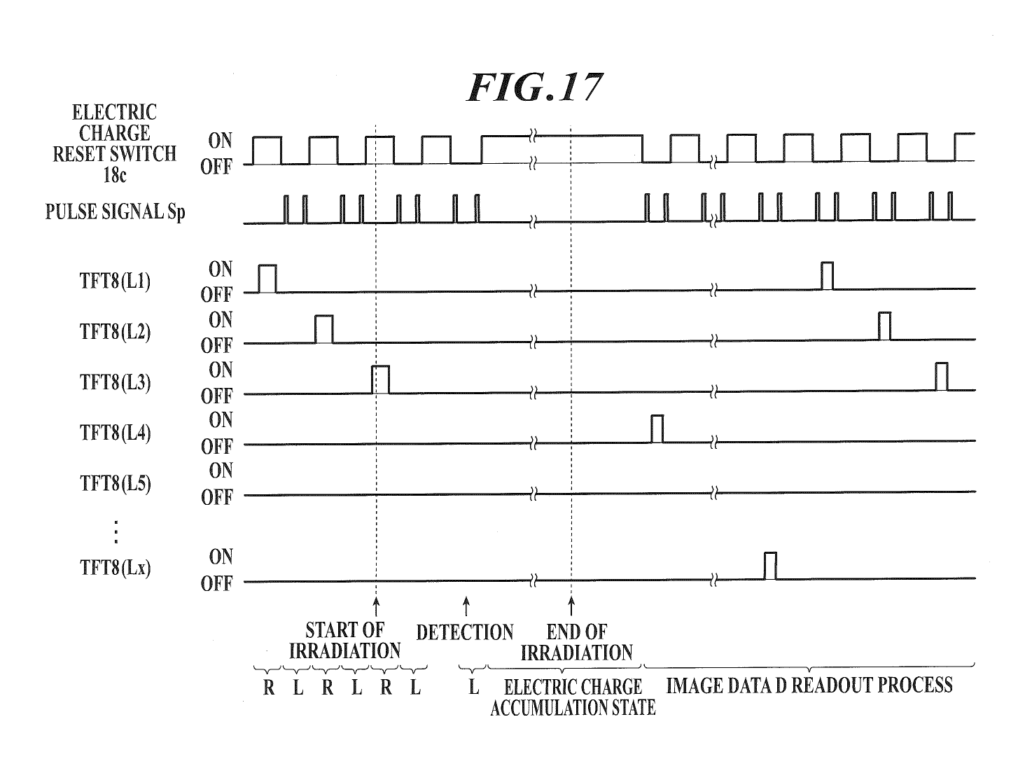

However, for example, as shown in FIG. 17, the irradiation may start just before or during the reset process carried out just before the leak data dleak readout process in which the value of the leak data dleak becomes equal to or greater than the threshold dleak_th for the first time; here, that reset process is the one carried out by applying ON voltage to the line L3 of the scan lines 5.

As with the case shown in FIG. 15, the value of the leak data dleak read out in the leak data dleak readout process right after the reset process carried out by applying ON voltage to the line L2 of the scan lines 5 is smaller than the threshold dleak_th because the value is a value before start of the irradiation. Meanwhile, the value of the leak data dleak read out in the leak data dleak readout process right after the reset process carried out by applying ON voltage to the line L3 of the scan lines 5 is equal to or greater than the threshold dleak_th because the value is a value after start of the irradiation.

In either of the cases shown in FIGS. 15 and 17, the reset process of the radiation detection elements 7 right after the leak data dleak readout process in which the value of the leak data dleak becomes equal to or greater than the threshold dleak_th is not carried out. When the value of the leak data dleak is equal to or greater than the threshold dleak thin the subsequent leak data dleak readout process, start of the irradiation is detected.

In the case shown in FIG. 17, as with the case shown in FIG. 15, the reset process of the radiation detection elements 7 right after the leak data dleak readout process in which the value of the leak data dleak becomes equal to or greater than the threshold dleak_th is not carried out. Accordingly, generation of the line defect in the image data D can be prevented at least in this part.

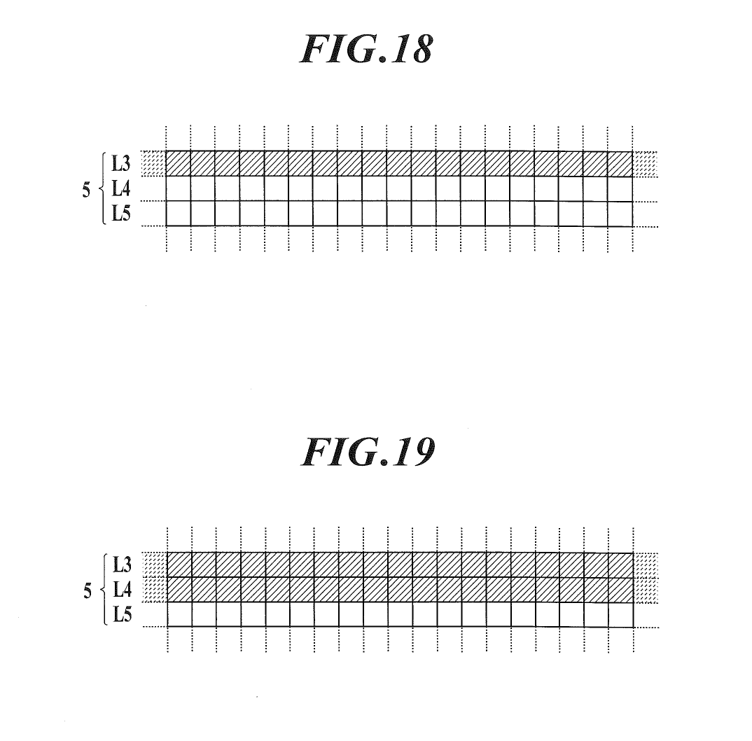

However, the reset process of the radiation detection elements 7 carried out by applying ON voltage to the line L3 of the scan lines 5 is carried out. Therefore, the line defect may be generated in the image data D in the part corresponding to the radiation detection elements 7 connected to the line L3 of the scan lines 5 (refer to the hatched part of FIG. 18).

Thus, even with this characteristic configuration of the radiation image capturing apparatus 1 according to this embodiment, it cannot be clearly said that generation of the line defect in the image data D read out can be always and certainly prevented.

However, in such a case as that shown in FIG. 17, if, as with the conventional configuration, the reset process of the radiation detection elements 7 is carried out right after the leak data dleak readout process in which the value of the leak data dleak becomes equal to or greater than the threshold dleak_th, the line defect of at least two successive lines is generated as shown in FIG. 19.

As can be seen by comparing FIGS. 18 and 19, with the configuration of this embodiment, the reset process of the radiation detection elements 7 right after the leak data dleak readout process in which the value of the leak data dleak becomes equal to or greater than the threshold dleak_th is not carried out. Hence, even though it cannot be said that the configuration of this embodiment can always prevent generation of the line defect, it can be said that the configuration thereof can prevent unnecessary increase in the number of lines of the line defect appearing in the image data D. Thus, the line defect to be generated can be certainly reduced.

For example, as shown in FIG. 19, if the line defect of multiple successive lines is generated, the line defect part may cross or overlap an important part such as a patient's lesion site. The lesion site captured may disappear from its radiation image or become difficult to see by image correction for the line defect.

However, in this embodiment, the line defect is not generated, or even if the line defect is generated, the line defect is made up of only one line or so as shown in FIG. 18. A patient's lesion site is normally larger than the width of the line defect of one line. Therefore, for example, even if the line defect crossing a patient's lesion site or the like is generated, the image of the line defect part can be corrected using correct image data D of the parts where the lesion site or the like is correctly captured such as the parts around the line defect. An important part such as a patient's lesion site can thereby be correctly restored.

This makes it possible to certainly prevent an important part such as a patient's lesion site from disappearing from its radiation image or becoming difficult to see by image correction, and accordingly a radiation image in which an important part such as a patient's lesion site is correctly captured can be acquired.

### [Effects]

As described so far, according to the radiation image capturing apparatus 1 and the radiation image capturing system 50 of this embodiment, the control unit 22 of the radiation image capturing apparatus 1 does not carry out the subsequent reset process of the radiation detection elements 7 when the value of the read-out leak data dleak becomes equal to or greater than a predetermined threshold (first threshold) dleak_th.

Instead, the control unit 22 carries out the leak data dleak readout process again, and when the value of the leak data dleak read out in the repeated readout process is again equal to or greater than the threshold dleak_th, the control unit 22 judges that the irradiation has started. The control unit 22 then commands the functional parts to carry out the processes for when the irradiation has started.

On the other hand, when the value of the leak data dleak read out in the repeated readout process is smaller than the threshold dleak_th, the control unit 22 judges that the irradiation has not started yet. Then, the control unit 22 returns to the state for alternately carrying out the leak data dleak readout process and the reset process of the radiation detection elements 7.

If the radiation image capturing apparatus 1 is irradiated, the value of the leak data dleak read out stays at the high level. On the other hand, if, for example, the radiation image capturing apparatus 1 is vibrated or static electricity is generated therein, the value of the leak data dleak read out instantaneously rises but immediately returns to the original low level.

Therefore, in the above configuration, when the value of the read-out leak data dleak is equal to or greater than the threshold dleak_th two times or more in a row, it means that irradiation of the radiation image capturing apparatus 1 has started. Hence, the control unit 22 of the radiation image capturing apparatus 1 judges that the irradiation has started in such a case. Accordingly, start of the irradiation can be correctly detected.

When the value of the leak data dleak that is once equal to or greater than the threshold dleak_th but smaller than the threshold dleak_th in the next leak data dleak readout process, it means that such an event as the radiation image capturing apparatus 1 being vibrated or static electricity being generated therein has occurred. At least it does not mean that the irradiation has started.

Hence, the control unit 22 of the radiation image capturing apparatus 1 judges that the irradiation has not started yet in such a case. Accordingly, false detection of start of the irradiation caused by, for example, the radiation image capturing apparatus 1 being vibrated or static electricity being generated therein can be certainly prevented.

Further, the control unit 22 returns to the state for alternately carrying out the leak data dleak readout process and the reset process of the radiation detection elements 7 in such a case. Accordingly, for example, even if the irradiation actually starts immediately thereafter, start of the irradiation can be correctly detected and a radiation image can be correctly captured.

In addition, the control unit 22 does not carry out the subsequent reset process of the radiation detection elements 7 when the value of the read-out leak data dleak becomes equal to or greater than the threshold dleak_th. Accordingly, if the irradiation has actually started, the effective electric charges which are generated by irradiation in the radiation detection elements 7 and accumulated therein can be certainly prevented from being lost by the reset process.

Accordingly, it is possible to certainly prevent generation of the line defect as that shown in FIG. 14 in the image data D read out from the radiation detection elements 7 in the following image data D readout process (refer to FIG. 15), or certainly reduce the line defect to be generated.

### [Acquirement of Offset Data O]

As shown in FIG. 16, when the value of the read-out leak data dleak becomes equal to or greater than the threshold dleak_th due to the radiation image capturing apparatus 1 being vibrated or the like, the irradiation start detection process (i.e., the leak data dleak readout process and the reset process of the radiation detection elements 7 being alternately carried out) is restarted with the reset process of the radiation detection elements 7 skipped one time. That is, the reset process of the radiation detection elements 7 is restarted in such a way that the timing of the reset process thereof is moved one timing behind.

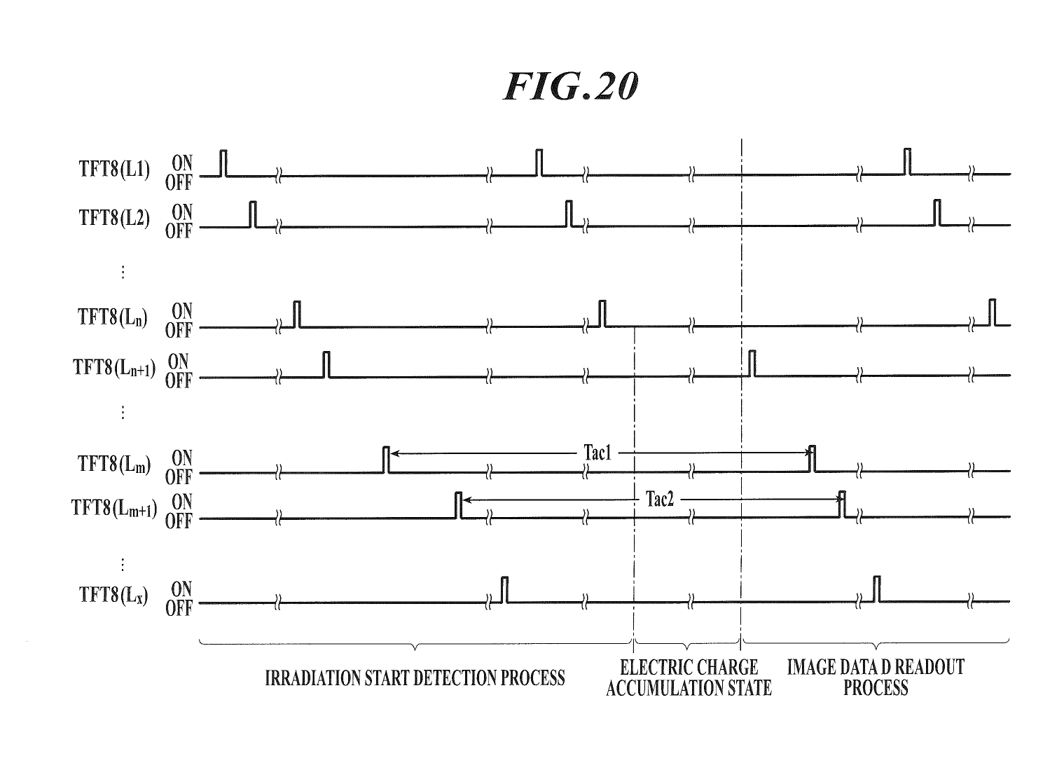

For example, as shown in FIG. 20, when the value of the leak data dleak read out in the leak data dleak readout process (omitted in FIG. 20, refer to FIG. 16 or other drawings) right after application of ON voltage to the line Lm of the scan lines 5 is equal to or greater than the threshold dleak_th, but the value of the leak data dleak read out in the next leak data dleak readout process with no subsequent reset process carried out is smaller than the threshold dleak_th, the control unit 22 judges that the irradiation has not started yet and restarts the reset process of the radiation detection elements 7 by applying ON voltage to the line Lm+1 of the scan lines 5.

Then, for example, the value of the leak data dleak read out in the leak data dleak readout process right after application of ON voltage to the line Ln of the scan lines 5 is equal to or greater than the threshold dleak_th, and the value of the leak data dleak read out in the next leak data dleak readout process with no subsequent reset process carried out is again equal to or greater than the threshold dleak_th, the control unit 22 judges that the irradiation has started.

In this case, as described above, detecting start of the irradiation, the control unit 22 of the radiation image capturing apparatus 1 controls the gate driver 15b of the scan driving unit 15 to apply OFF voltage to the lines L1 to Lx of the scan lines 5 so as to set the TFTs 8 to the OFF state, thereby shifting to the electric charge accumulation state. After a predetermined time, the control unit 22 controls the gate driver 15b thereof to apply ON voltage to the lines L1 to Lx of the scan lines 5 starting from the line Ln+1 of the scan lines 5, thereby carrying out the image data D readout process.

At the time, in each radiation detection element 7, the so-called dark electric charge (also called dark current) is constantly generated by, for example, thermal excitation caused by heat (temperature) of the radiation detection element 7 itself. An offset originated from dark electric charge is superimposed on the image data D which is read out in the following image data D readout process.

The amount of the offset (offset amount) of dark electric charge is determined by the amount of electric charge accumulated in the radiation detection element 7 while the TFT 8 is in the OFF state before the image data D readout process, that is, during a time period such as a time Tact or a time Tact in FIG. 20 (a time Tac is hereafter referred to as an effective accumulation time). If the effective accumulation times Tac are different, the amounts of dark electric charges accumulated and the offset amounts of dark electric charges are different as well.

In the case shown in FIG. 20, the timing to apply ON voltage to the line Lm+1 of the scan lines 5 after applying ON voltage to the line Lm of the scan lines 5 is moved one timing behind because the reset process is skipped one time as a result of the value of the read-out leak data dleak once being equal to or greater than the threshold dleak_th due to the radiation image capturing apparatus 1 being vibrated or the like. Consequently, at least the effective accumulation time Tact of the line Lm of the scan lines 5 is longer than the effective accumulation time Tac2 of the line Lm+1 of the scan lines 5 by a time length corresponding to the timing being moved one timing behind.

Thus, the offset amount of dark electric charge superimposed on the image data D read out from each radiation detection element 7 connected to the line Lm of the scan lines 5 is greater than the offset amount of dark electric charge superimposed on the image data D read out from each radiation detection element 7 connected to the line Lm+1 of the scan lines 5 by the above-described difference between the effective accumulation times Tact and Tac2.

As described above, the configuration in which the subsequent reset process is not carried out when the value of the read-out leak data dleak becomes equal to or greater than the threshold dleak_th makes effective accumulation times Tac different depending on the scan lines 5 by the time length corresponding to the timing to apply ON voltage to each line L of the scan lines 5 in the reset process of the radiation detection elements 7 being moved behind.

Consequently, the offset amounts of dark electric charges superimposed on the image data D read out from the radiation detection elements 7 are different depending on the scan lines 5. Hence, a problem arises, for example, that even if the radiation incidence surface R of the radiation image capturing apparatus 1 (for example, refer to FIG. 1) is uniformly irradiated, the values of the read-out image data D (including the offset amounts of dark electric charges) are different depending on the scan lines 5.

However, as described above, if the offset data O is acquired by carrying out the same process sequence as the process sequence from the irradiation start detection process to the image data D readout process inclusive, the above-described problem or the like can be certainly solved.

For example, when the processes up to the image data D readout process are carried out by following the process sequence shown in FIG. 20, as shown in FIG. 21, after the image data D readout process, the offset data O is acquired by carrying out the same process sequence as the process sequence shown in FIG. 20.

Incidentally, in this case, the offset data O corresponds to the offset amount of dark electric charge superimposed on the image data D, and hence the radiation image capturing apparatus 1 is not irradiated. Therefore, the irradiation start detection process does not need to be carried out to read out the offset data O. The reason why in FIG. 21 the “detection operation” is written instated of the “irradiation start detection process” is that although the leak data dleak readout process and the reset process of the radiation detection elements 7 are carried out, judgment (detection) of start of irradiation based on the read-out leak data dleak is not carried out. This is because the judgment is unnecessary.

With the configuration in which the offset data O is acquired as described above, even when the effective accumulation times Tac are different between the scan lines 5 as described above, with respect to each scan line 5, the effective accumulation time Tac to read out the image data D and the effective accumulation time Tac to read out the offset data O are the same.

More specifically, for example, even if the effective accumulation time Tact of the line Lm of the scan lines 5 is different from the effective accumulation time Tac2 of the line Lm+1 of the scan lines 5 because the value of the read-out leak data dleak once being equal to or greater than the threshold dleak_th is due to the radiation image capturing apparatus 1 being vibrated or the like, the effective accumulation time Tact of the line Lm of the scan lines 5 to read out the image data D is the same as the effective accumulation time Tact of the line Lm thereof to read out the offset data O because their process sequences are the same. Similarly, the effective accumulation time Tac2 of the line Lm+1 of the scan lines 5 to read out the image data D is the same as the effective accumulation time Tac2 of the line Lm+1 thereof to read out the offset data O.

The effective accumulation time Tac to readout the image data D and the effective accumulation time Tac to read out the offset data O of any of the scan lines 5 are the same. Thus, the offset amount of dark electric charge superimposed on the image data D read out from each radiation detection element 7 is the same as the value of the offset data O read out in the offset data O readout process.

With respect to each radiation detection element 7, the offset amount of dark electric charge superimposed on the image data D is offset by the offset data O by subtracting the offset data O from the read-out image data D by using the following expression (1). The calculated true image data D* indicates a value not including the offset amount of dark electric charge.

D*=D−O (1)

That is, the true image data D* (i.e., the value thereof) calculated in the above manner is a value not influenced by the length of the effective accumulation time Tac but based on only the electric charge generated by irradiation in the radiation detection element 7. Accordingly, based on not the read-out image data D itself but the thus calculated true image data D*, a radiation image with no influence by the offset amount of dark electric charge can be created, the offset amount being determined by the length of the effective accumulation time Tac.

### [Modifications]

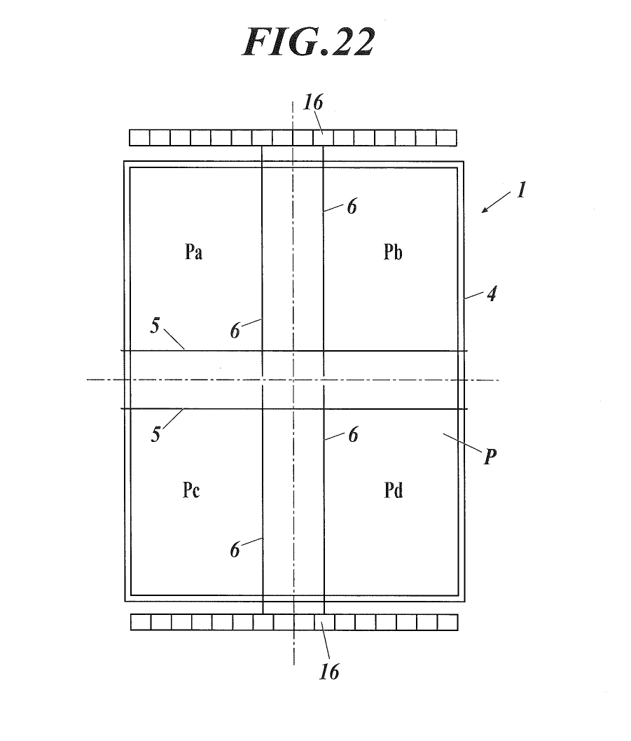

In the case of, for example, FIGS. 15 and 16, in the irradiation start detection process, the reset process of the radiation detection elements 7 is carried out by sequentially applying ON voltage to the scan lines 5 starting from the line L1 of the scan lines 5 from the scan driving unit 15. However, for example, as shown in FIG. 22, there is a case where the detection unit P of the radiation image capturing apparatus 1 (refer to FIG. 2 or 3) is divided into four areas Pa to Pd.

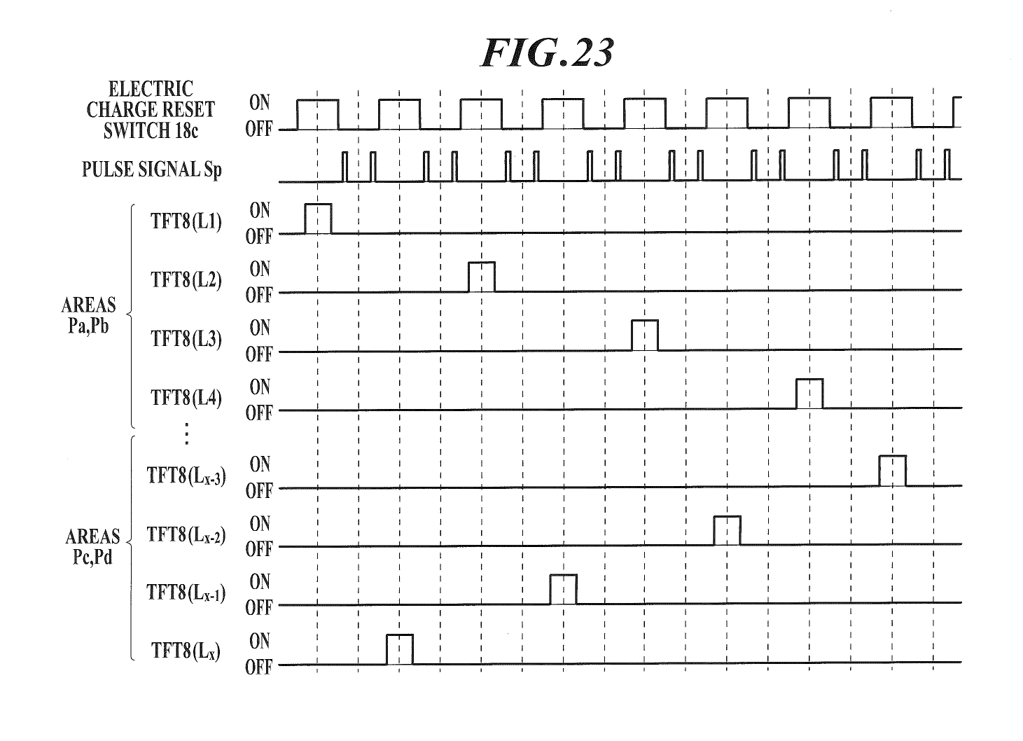

In such a case, for example, as shown in FIG. 23, the reset process of the radiation detection elements 7 can be carried out by shifting the scan lines 5 to which ON voltage is applied one by one starting from the scan lines 5 placed on the end parts of the detection unit P made up of the areas Pa to Pd (refer to FIG. 22); more specifically, starting from the line L1 of the scan lines 5 on the areas Pa and Pb and then the line Lx of the scan lines 5 on the areas Pc and Pd; to the scan lines 5 placed on the center part thereof (omitted in FIG. 23).

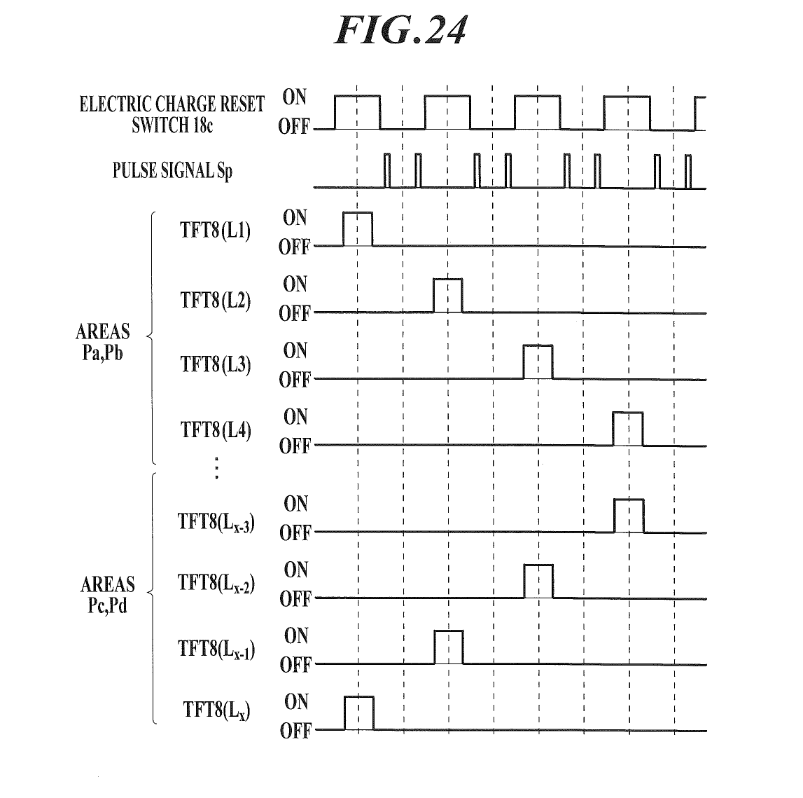

Timings to apply ON voltage to the scan lines 5 do not need to be different between the areas Pa and Pb and the areas Pc and Pd as shown in FIG. 23. For example, as shown in FIG. 24, ON voltage can be simultaneously applied to multiple scan lines 5 placed on the areas Pa to Pd while shifting the scan lines 5 to which ON voltage is applied.

Further, for example, as shown in FIG. 25, it is also possible to make timings of the leak data dleak readout process and the timings of the reset process of the radiation detection elements 7 different between the areas Pa and Pb and the areas Pc and Pd and sequentially apply ON voltage to the scan lines 5 one by one.

In the case of FIGS. 23 to 25, the scan lines 5 to which ON voltage is applied are shifted starting from the scan lines 5 placed on the outer side to the scan lines 5 placed on the inner side. Although not illustrated, it is also possible to shift the scan lines 5 to which ON voltage is applied starting from the scan lines 5 placed on the inner side to the scan lines placed on the outer side.

In any of the modifications described above and other modifications, as with the above-described embodiment, the control unit 22 of the radiation image capturing apparatus 1 does not detect start of irradiation when the value of the leak data dleak read out in the first leak data dleak readout process is equal to or greater than the threshold dleak_th. The control unit 22 detects start of irradiation when the value of the leak data dleak read out in the second leak data dleak readout process is again equal to or greater than the threshold dleak_th.

When the value of the leak data dleak read out in the second leak data dleak readout process is smaller than the threshold dleak_th, the control unit 22 does not detect start of irradiation and restarts the irradiation start detection process. The reset process of the radiation detection elements 7 right after the leak data dleak readout process in which the value of the leak data dleak becomes equal to or greater than the threshold dleak_th for the first time is not carried out.

With the configuration, the advantageous effects of the above-described embodiment can be accurately exerted by the modifications as well.

Incidentally, in the above-described modifications, for example, if the value of the leak data dleak read out in the first leak data dleak readout process in the areas Pa and Pb is equal to or greater than the threshold dleak_th, and judgment of whether or not the value of the leak data dleak read out in the second leak data dleak readout process is again equal to or greater than the threshold dleak_th is made based on the value of the leak data dleak read out in the other areas Pc and Pd, the following problem may arise.

That is, for example, if irradiation of the radiation image capturing apparatus 1 starts in a situation in which the irradiation field is limited to the areas Pa and Pb of the detection unit P of the radiation image capturing apparatus 1, the value of the leak data dleak read out in the leak data dleak readout process in the areas Pa and Pb becomes equal to or greater than the threshold dleak_th.

However, the value of the leak data dleak read out in the leak data dleak data process in the areas Pc and Pd remains below the threshold dleak_th because the areas Pc and Pd are not irradiated.

In such a situation, if the areas (Pc and Pd) for the second leak data dleak readout process are different from the areas (Pa and Pb) for the first leak data dleak readout process as described above, even though the radiation image capturing apparatus 1 have been irradiated although it is only over the areas Pa and Pb, the value of the leak data dleak becomes smaller than the threshold dleak_th in the second leak data dleak readout process after the value of the leak data dleak becomes equal to or greater than the threshold dleak_th in the first leak data dleak readout process. The control unit 22 then judges that the irradiation has not started yet by judging the value thereof read out in the first leak data dleak readout process is due to, for example, the radiation image capturing apparatus 1 being vibrated. Accordingly, start of irradiation of the radiation image capturing apparatus 1 cannot be correctly detected.

Hence, when the detection unit P of the radiation image capturing apparatus 1 is divided into multiple areas as described above, it is desirable to make judgment of whether or not the value of the leak data dleak is equal to or greater than the threshold dleak_th two times in a row by using the leak data dleak read out in the same area (or areas).

### [Display Examples on Console]

When start of irradiation of the radiation image capturing apparatus 1 is not detected as described above, for example, it is possible to notify an operator such as a radiological technologist about how large (great) the value of the leak data dleak read out in the first leak data dleak readout process is, the value being equal to or greater than the threshold dleak_th.

In the radiation image capturing apparatus 1 according to this embodiment, when the value of the leak data dleak read out in the first leak data dleak readout process is equal to or greater than the threshold dleak_th and the value of the leak data dleak read out in the second leak data dleak readout process is smaller than the threshold dleak_th, as described above, the control unit 22 does not detect start of irradiation and returns to the irradiation start detection process.

At the time, the value of the leak data dleak read out in the first leak data dleak readout process is transmitted to the console 58 (refer to FIG. 7 or 8) from the radiation image capturing apparatus 1. The console 58 can display this value on the display unit 58a as it is or by converting this transmitted value into an indication that corresponds to the value; for example, by classifying the value as, for example, “strong” or “weak” according to a degree of the value.

Incidentally, for such a reason as aging deterioration of the TFTs 8 which are the switch elements of the radiation detection elements 7, the electric charges q shown in FIG. 9 leaking to the signal lines 6 from the radiation detection elements 7 via the TFTs 8 may increase, and accordingly the value of the read-out leak data dleak may increase as though the offsets are superimposed on the read-out leak data dleak.

Further, if, for example, the usage environment of the radiation image capturing apparatus 1 changes, the amplitude of noise superimposed on the read-out leak data dleak may increase.

In either of the cases, the value of the leak data dleak read out before start of irradiation, namely, before an irradiation start time shown in FIG. 11 (refer to a time t1 in FIG. 11) may increase influenced thereby. For example, the value of the leak data dleak read out may increase influenced by noise and become equal to or greater than the threshold dleak_th even though the radiation image capturing apparatus 1 is not irradiated, which results in false detection of start of irradiation.

Meanwhile, in the above-described embodiment, as shown in, for example, FIG. 15, when start of irradiation is detected, the reset process of the radiation detection elements 7 stops, and the radiation image capturing apparatus 1 shifts to the electric charge accumulation state. At the time, the leak data dleak readout process also stops.

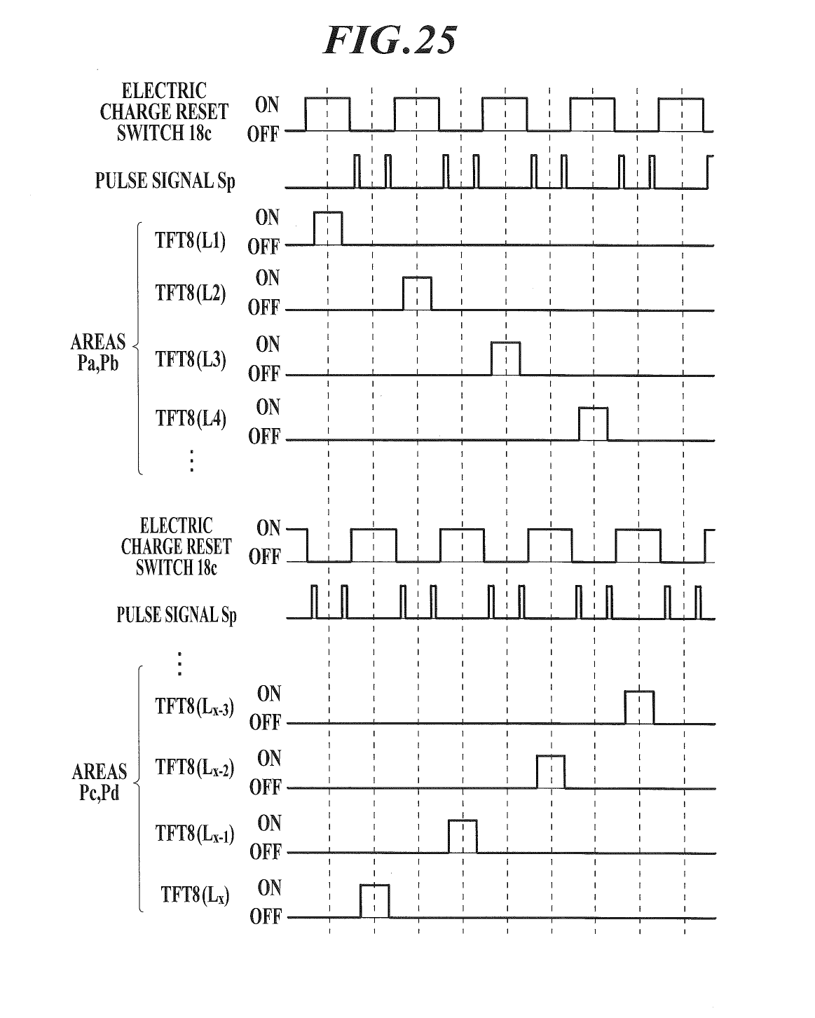

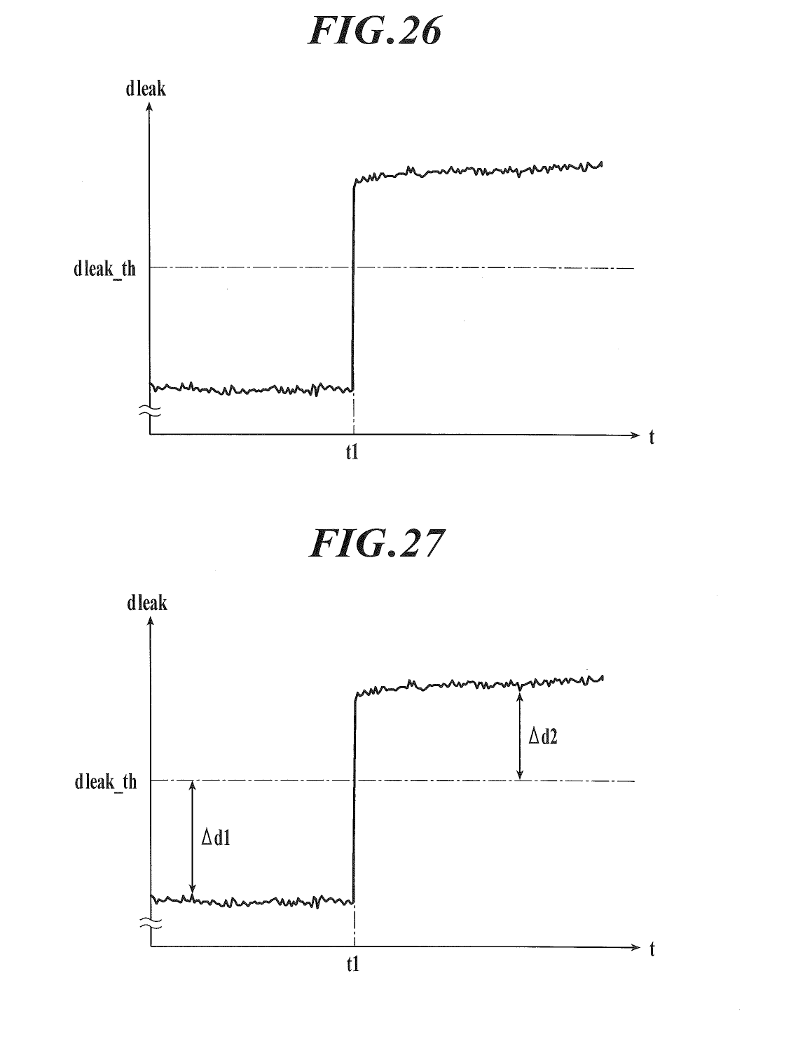

Here, if the leak data dleak readout process continues after detection of start of irradiation (at the time, the reset process stops), for example, as shown in FIG. 26, the value of the leak data dleak read out fluctuates above the threshold dleak_th.

For such a reason as aging deterioration of the TFTs 8, the value of the leak data dleak after start of irradiation may become smaller over time. If the value of the leak data dleak after start of irradiation becomes smaller, the value of the leak data dleak read out may not become equal to or greater than the threshold dleak_th even when the radiation image capturing apparatus 1 is irradiated. Consequently, start of irradiation may be unable to be detected.

To avoid these problems, for example, as shown in FIG. 27, a difference Δd1 between the value (before-irradiation value) of the leak data dleak read out before actual start of irradiation (hereafter referred to as dleak1) and the threshold dleak_th (first threshold) and/or a difference Δd2 between the value (after-irradiation value) of the leak data dleak read out after actual start of irradiation (hereafter referred to as dleak2) and the threshold dleak_th are calculated.

The differences Δd1 and Δd2 are calculated in the radiation image capturing apparatus 1 or the console 58. The calculation is carried out constantly, regularly at such timing as when maintenance is carried out or occasionally at such timing when a predetermined number of radiation images is captured. In order to calculate the difference Δd2, as described above, the radiation image capturing apparatus 1 continues the leak data dleak readout process after detection of start of irradiation.

The subject for calculating the difference Δd1 or Δd2 with the threshold dleak_th may be, for example, the maximum value of the leak data dleak1 read out before actual start of irradiation or the minimum value of the leak data dleak2 read out after actual start of irradiation. Alternatively, the subject may be the average value of the leak data dleak1 or dleak2 read out before or after actual start of irradiation.

In addition, the console 58 displays on the display unit 58a the above-described difference Δd1 and/or the difference Δd2 calculated in the radiation image capturing apparatus 1 and transmitted to the console 58 or calculated in the console 58 itself. A radiological technologist, a maintainer or the like checks the difference Δd1 and/or the difference Δd2 and takes a measure such as resetting the threshold dleak_th to an appropriate value as required.

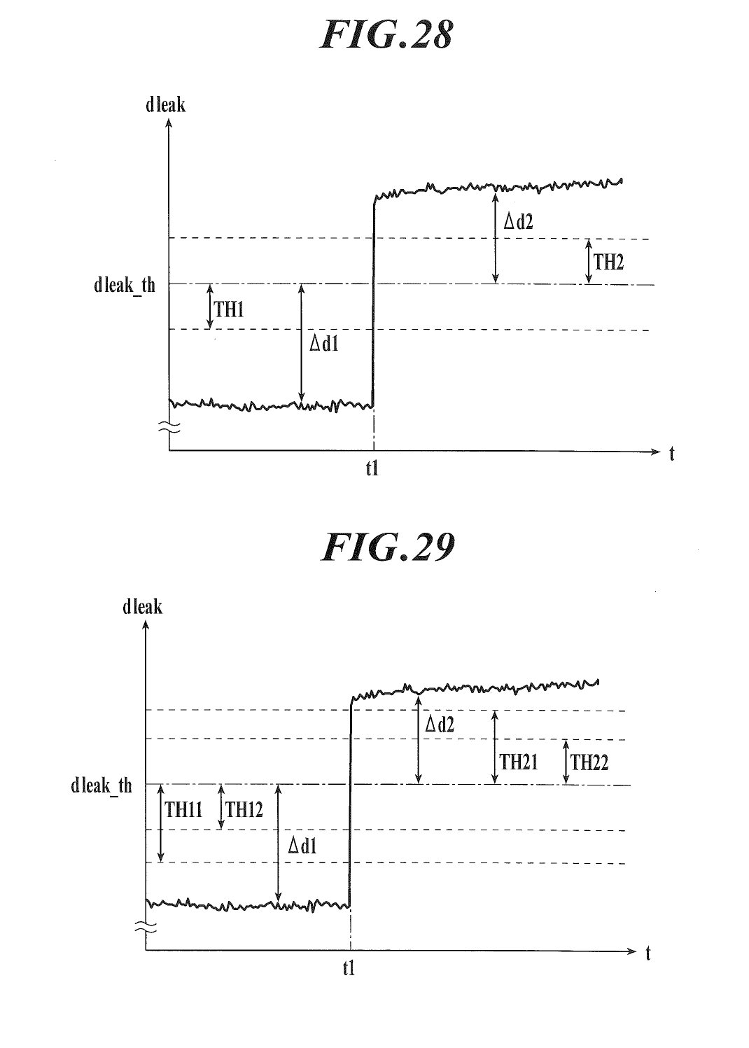

In addition, for example, as shown in FIG. 28, ranges defined by thresholds TH1 and TH2 are set for the absolute values of the above-described differences Δd1 and Δd2, respectively. When the absolute value of the difference Δd1 or Δd2 is within the predetermined range TH1 or TH2, and hence the value of leak data dleak is close to the threshold dleak_th, the console 58 may issue a warning.

With such a configuration, a radiological technologist, a maintainer or the like can take a required measure such as resetting the threshold dleak_th to an appropriate value in response to a warning. The warning can be issued by displaying a predetermined warning indication on the display unit 58a of the console 58, by sound or by any other appropriate means.

Further, instead of suddenly issuing a warning, or together with the warning, for example, as shown in FIG. 29, thresholds TH11 and TH12 are set for the absolute value of the above-described difference Δd1, and thresholds TH21 and TH22 are set for the absolute value of the above-described difference Δd2.

At a stage where the absolute value of the difference Δd1 is equal to or greater than the threshold TH11, or at a stage where the absolute value of the difference Δd2 is equal to or greater than the threshold TH21, for example, the console 58 displays an indication of “GOOD” on the display unit 58a to draw attention of a radiological technologist, a maintainer or the like and notify him/her that the value of the leak data dleak1 read out before actual start of irradiation is still small enough, or the value of the leak data dleak2 read out after actual start of irradiation is still large enough.

At a stage where the absolute value of the difference Δd1 is smaller than the threshold TH11 and equal to or greater than the threshold TH12, or at a stage where the absolute value of the difference Δd2 is smaller than the threshold TH21 and equal to or greater than the threshold TH22, for example, the console 58 displays an indication of “CAUTION” on the display unit 58a to draw attention of a radiological technologist, a maintainer or the like and notify him/her that the value of the leak data dleak1 read out before actual start of irradiation is somewhat large, or the value of the leak data dleak2 read out after actual start of irradiation is somewhat small, and hence caution is required.

At a stage where the absolute value of the difference Δd1 is smaller than the threshold TH12, for example, the console 58 displays an indication of “DANGER” on the display unit 58a to draw attention of a radiological technologist, a maintainer or the like and notify and warn him/her that the value of the leak data dleak1 read out before actual start of irradiation is large, and hence false detection of start of irradiation may occur.

Similarly, at a stage where the absolute value of the difference Δd2 is smaller than the threshold TH22, for example, the console 58 displays an indication of “DANGER” on the display unit 58a to draw attention of a radiological technologist, a maintainer or the like and notify and warn him/her that the value of the leak data dleak2 read out after actual start of irradiation is small, and hence the value of the leak data dleak read out may be unable to become equal to or greater than the threshold dleka th, and therefore start of irradiation may be unable to be detected. Incidentally, in the above cases, sound or the like may be used to draw attention or notify.

Such a configuration also allows a radiological technologist, a maintainer or the like to take a required measure such as resetting the threshold dleak_th to an appropriate value in response to a warning.

When a thin patient is irradiated, radiation more easily penetrates the patient's body and reaches the radiation image capturing apparatus 1 than when a fat patient is irradiated. That is, the value of the read-out leak data dleak is larger when a radiation image of a thin patient is captured. Hence, for example, if the radiation image capturing apparatus 1 having decreased sensitivity and the value of the leak data dleak2 read out after actual start of irradiation smaller than before is used for capturing a radiation image of a thin patient, the value of the read-out leak data dleak2 sufficiently exceeds the threshold dleak_th. Accordingly, it is possible to use such a radiation image capturing apparatus 1 for thin patients only.

The values of the leak data dleak1 read out before actual start of irradiation, the values of the leak data dleak2 read out after actual start of irradiation and the differences Δd1 and Δd2 may be stored in time series. Based on these data, information such as change in the usage environment of the radiation image capturing apparatus 1 and a degree of aging deterioration of the TFTs 8 can be known.

In the above configuration examples, it is described that a radiological technologist, a maintainer or the like who checks the displayed differences Δd1 and/or Δd2 or the like takes a measure such as resetting the threshold dleak_th to an appropriate value as required. Alternatively, the console 58 or the radiation image capturing apparatus 1 may automatically take a required measure such as resetting the threshold dleak_th to an appropriate value based on, for example, fluctuation of the values of the leak data dleak1 or dleak2 or the differences Δd1 or Δd2 stored in time series.

As described above, it is possible to continue the leak data dleak readout process after detection of start of irradiation (while stopping the reset process of the radiation detection elements 7). Instead, as shown in, for example, FIG. 15, it is possible to stop the leak data dleak readout process together with the reset process of the radiation detection elements 7 at the time of detection of start of irradiation. In this case, the value of the leak data dleak2 read out after actual start of irradiation can be estimated from the value of the read-out image data D.

The value of the leak data dleak depends on the radiation dose per unit time with which the radiation image capturing apparatus 1 is irradiated, i.e., the dose rate. Meanwhile, the value of the image data D depends on the radiation dose with which the radiation image capturing apparatus 1 is irradiated, i.e., the radiation dose from the start to the end of irradiation.

Therefore, if, as described above, the value of the leak data dleak2 read out after actual start of irradiation is estimated from the value of the read-out image data D, the console 58 or the radiation image capturing apparatus 1 which makes this estimation measures an irradiation time, acquires irradiation time information from the radiation generation apparatus 55 or the like, or acquires the irradiation time information by a radiological technologist or the like inputting the irradiation time therein, so as to acquire the irradiation time information.

The value of the leak data dleak2 read out after actual start of irradiation, the value thereof being dependant on the radiation rate, i.e., the radiation dose per unit time, can be estimated by dividing the value of the read-out image data D by the irradiation time.

With this configuration, there is no need to continue the leak data dleak readout process after detection of start of irradiation. Because the readout process which consumes a relatively large amount of power can be omitted, waste of power of the battery 24 (refer to, for example, FIG. 3) can be certainly prevented.

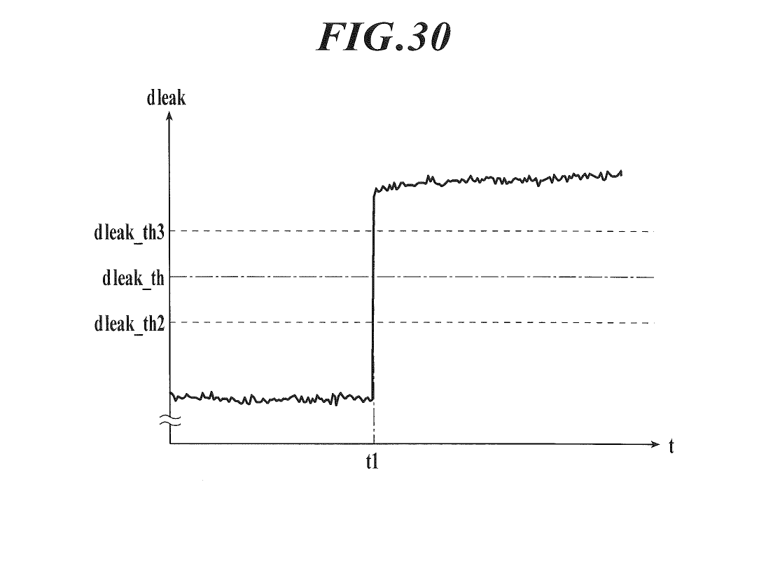

Further, when the values of the leak data dleak1 and dleak2 and the calculated differences Δd1 and Δd2 are transmitted from the radiation image capturing apparatus 1 to the console 58 as described above, those values and the like may be conditionally transmitted. For example, as shown in FIG. 30, those values and the like may be transmitted to the console 58 only when the value of the leak data dleak1 read out before actual start of irradiation is equal to or greater than a second threshold dleak_th2 set to be smaller than the threshold dleak_th, or when the value of the leak data dleak2 read out after actual start of irradiation is equal to or smaller than a third threshold dleak_th3 set to be greater than the threshold dleak_th.

With this configuration, the values and the like are transmitted from the radiation image capturing apparatus 1 to the console 58 only when caution is required because the value of the leak data dleak1 read out before actual start of irradiation is large or the value of the leak data dleak2 read out after actual start of irradiation is small.

Accordingly, unnecessary transmission of data from the radiation image capturing apparatus 1 to the console 58 can be avoided, and hence waste of power of the battery 24 of the radiation image capturing apparatus 1 can be certainly prevented.

With the above configuration, it is possible to certainly prevent false detection of start of irradiation due to increase in the value of the leak data dleak1 read out before actual start of irradiation caused by aging deterioration of the TFTs 8 which are the switch elements for the radiation detection elements 7 of the radiation image capturing apparatus 1 or due to change in the usage environment of the radiation image capturing apparatus 1. The above configuration can also certainly prevent start of irradiation from being unable to be detected due to decrease in the value of the leak data dleak2 read out after actual start of irradiation.

Then, a required measure can be appropriately taken; for example, a radiological technologist, a maintainer or the like resets the threshold dleak_th set for the irradiation start detection process to an appropriate value, which enables the irradiation start detection process to be carried out more correctly.

Incidentally, in the above [Display Examples on Console], the case where start of irradiation is detected based on the leak data dleak read out in the leak data dleak readout process is described. However, this technique is not limited to such a case and can also be applied to cases where start of irradiation is detected by other methods.

For example, although not illustrated, the technique can be applied to such a case where the radiation image capturing apparatus 1 is provided with a radiation sensor that raises its output value when irradiation thereof starts. The control unit 22 detects start of the irradiation when the output value of the radiation sensor becomes equal to or greater than a predetermined threshold value.

In this case, the output value output from the radiation sensor changes in exactly the same manner as the value of the leak data dleak shown in FIG. 26 and other drawings. Therefore, it is possible to notify, draw attention of, warn a radiological technologist, a maintainer or the like in the above-described manner based on the output value output from the radiation sensor before detection of start of irradiation or the output value output from the radiation sensor after detection of start of irradiation.

Further, as disclosed in, for example, Japanese Patent Application Laid-Open Publication No. 2009-219538, when irradiation of the radiation image capturing apparatus 1 starts, and electric charges are generated in the radiation detection elements 7, the electric charges flow out from the radiation detection elements 7 to the bias lines 9 to which the radiation detection elements 7 are connected, and a current value I of the current flowing through the bias lines 9 increases. Start of the irradiation can be detected by using this relation.

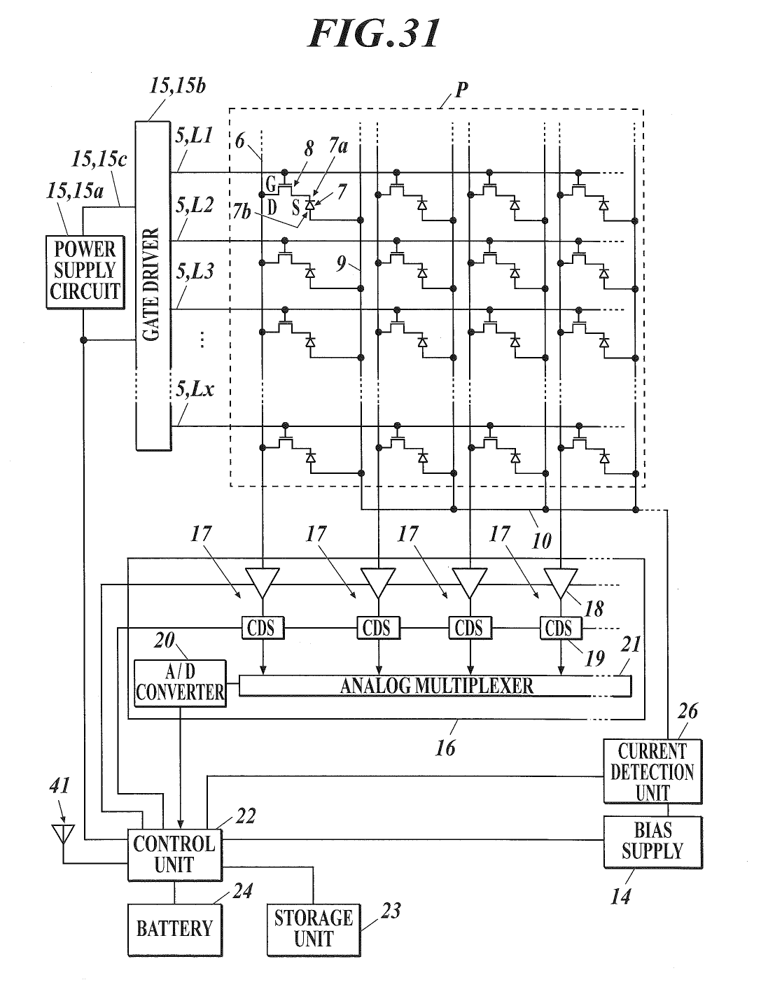

More specifically, for example, as shown in FIG. 31, a current detection unit 26 is provided on the bias lines 9 or their tie line 10 so that the current detection unit 26 detects the current value I of the current flowing through the bias lines 9 or the tie line 10 and outputs the current value I to the control unit 22.

With this configuration, the output value output from the current detection unit 26 changes in exactly the same manner as the value of the leak data dleak shown in FIG. 26 and other drawings. Therefore, it is possible to notify, draw attention of, warn a radiological technologist, a maintainer or the like in the above-described manner based on the output value output from the current detection unit 26 before detection of start of irradiation or the output value output from the current detection unit 26 after detection of start of irradiation.

Thus, the above-described technique can be applied not only to the radiation image capturing apparatus 1 configured to read out the leak data dleak as in the above-described embodiment but also to any other radiation image capturing apparatuses each (i) including an irradiation detection unit such as a radiation sensor or the current detection unit 26 which raises its output value when irradiation starts and (ii) configured to detect start of irradiation by the control unit 22 when the output value of the irradiation detection unit becomes equal to or greater than a predetermined threshold.

It is needless to say that the present invention is not limited to the above-described embodiment and the modifications but can be modified as appropriate without departing from the spirit of the present invention.

This application is based upon and claims the benefit of priority under 35 USC 119 of Japanese Patent Application No. 2012-139267 filed on Jun. 21, 2012, the entire disclosure of which, including the description, claims, drawings and abstract, is incorporated herein by reference in its entirety.

What is claimed is:

1. A radiation image capturing apparatus comprising:
a plurality of scan lines;
a plurality of signal lines;
a plurality of radiation detection elements arranged two-dimensionally;
a scan driving unit which applies ON voltage and OFF voltage to the scan lines, switching the ON voltage and the OFF voltage;
switch elements which are connected to the scan lines, and release electric charges accumulated in the radiation detection elements to the signal lines when the ON voltage is applied to the switch elements via the scan lines;
readout circuits which read out the electric charges released from the radiation detection elements as image data; and
a control unit which (i) alternately carries out (a) a leak data readout process in which the OFF voltage is applied to the scan lines from the scan driving unit so as to set the switch elements to an OFF state, and electric charges leaking from the radiation detection elements via the switch elements in the OFF state are read out as leak data and (b) a reset process of the radiation detection elements, thereby carrying out a detection process to detect start of irradiation of the radiation image capturing apparatus on the basis of the read-out leak data, and (ii) after detecting the start of the irradiation, controls at least the scan driving unit and the readout circuits in such a way that the readout circuits read out the electric charges released from the radiation detection elements as the image data, wherein
the control unit,
when a value of the leak data read out in the leak data readout process as a first leak data readout process is equal to or greater than a predetermined first threshold, repeats the leak data readout process as a second leak data readout process, skipping the reset process,
when a value of the leak data read out in the second leak data readout process is again equal to or greater than the first threshold, detects the start of the irradiation by judging that the irradiation has started, and controls at least the scan driving unit and the readout circuits in such a way that the scan driving unit and the readout circuits carry out processes for when the irradiation has started, and
when the value of the leak data read out in the second leak data readout process is smaller than the first threshold, does not detect the start of the irradiation by judging that the irradiation has not started, and alternately carries out the leak data readout process and the reset process again.

2. The radiation image capturing apparatus according to claim 1, wherein the control unit,
after carrying out an image data readout process to read out the image data from the radiation detection elements, controls at least the scan driving unit and the readout circuits in such a way that offsets originated from dark electric charges and superimposed on the image data are acquired as offset data, and
in order to acquire the offset data, carries out a process sequence identical to a process sequence from the detection process to the image data readout process inclusive without the irradiation, regardless of the control unit detecting the start of the irradiation.

3. A radiation image capturing system comprising:
the radiation image capturing apparatus according to claim 1 including a communication unit; and
a console including a display unit, wherein
when not detecting the start of the irradiation, the control unit of the radiation image capturing apparatus transmits to the console the value of the leak data read out in the first leak data readout process with the communication unit, and
the console displays the value transmitted from the radiation image capturing apparatus on the display unit with or without converting the value into an indication corresponding to the value.

4. A radiation image capturing system comprising:
the radiation image capturing apparatus according to claim 1 including a communication unit; and
a console including a display unit, wherein
the control unit of the radiation image capturing apparatus transmits to the console a before-irradiation value of the leak data read out before actual start of the irradiation with the communication unit, and
the console calculates a difference between the before-irradiation value and the first threshold, and displays the calculated difference on the display unit.

5. The radiation image capturing system according to claim 4, wherein the control unit of the radiation image capturing apparatus transmits to the console the before-irradiation value with the communication unit when the before-irradiation value is equal to or greater than a second threshold which is smaller than the first threshold.

6. A radiation image capturing system comprising:
the radiation image capturing apparatus according to claim 1 including a communication unit; and
a console including a display unit, wherein
after detecting the start of the irradiation, the control unit of the radiation image capturing apparatus stops the reset process while continuing the leak data readout process, and transmits to the console an after-irradiation value of the leak data read out after actual start of the irradiation, and
the console calculates a difference between the after-irradiation value and the first threshold, and displays the calculated difference on the display unit.

7. The radiation image capturing system according to claim 6, wherein after detecting the start of the irradiation, the control unit of the radiation image capturing apparatus stops both the reset process and the leak data readout process, and estimates an after-irradiation value from a value of the read-out image data instead of the after-irradiation value of the leak data readout after the actual start of the irradiation.

8. The radiation image capturing system according to claim 6, wherein the control unit of the radiation image capturing apparatus transmits to the console the after-irradiation value with the communication unit when the after-irradiation value is equal to or smaller than a third threshold which is greater than the first threshold.

9. The radiation image capturing system according to claim 4, wherein
the radiation image capturing apparatus calculates the difference instead of the console, and transmits the calculated difference to the console with the communication unit, and
the console displays the difference calculated by the radiation image capturing apparatus on the display unit.

10. The radiation image capturing system according to claim 4, wherein the console issues a warning when the difference is within a predetermined range set for the difference.

11. The radiation image capturing system according to claim 4, wherein the console classifies a degree of drawing attention as a stage according to a magnitude of the difference, and displays the difference on the display unit by changing an indication to draw attention according to the stage to which the magnitude of the difference belongs.

12. A radiation image capturing system comprising:
a radiation image capturing apparatus including:
a plurality of scan lines;
a plurality of signal lines;
a plurality of radiation detection elements arranged two-dimensionally;
a scan driving unit which applies ON voltage and OFF voltage to the scan lines, switching the ON voltage and the OFF voltage;
switch elements which are connected to the scan lines, and release electric charges accumulated in the radiation detection elements to the signal lines when the ON voltage is applied to the switch elements via the scan lines;
readout circuits which read out the electric charges released from the radiation detection elements as image data;
an irradiation detection unit which raises an output value when irradiation of the radiation image capturing apparatus starts;
a control unit which (i) detects the start of the irradiation when the output value is equal to or greater than a predetermined threshold, and (ii) after detecting the start of the irradiation, controls at least the scan driving unit and the readout circuits in such a way that the readout circuits read out the electric charges released from the radiation detection elements as the image data; and
a communication unit; and
a console including a display unit, wherein
the control unit of the radiation image capturing apparatus transmits to the console the output value read out before the detection of the start of the irradiation as a before-irradiation value with the communication unit, and
the console calculates a difference between the before-irradiation value and the threshold, and displays the calculated difference on the display unit.
